(19) United States
(12) Patent Application Publication
(10) Pub. No.: US 2019/0086234 A1
(43) Pub. Date: Mar. 21, 2019

(54) SYSTEMS AND METHODS FOR DISPLAYING RESOURCE SAVINGS

(71) Applicant: ELUTIONS Inc., Tampa, FL (US)

(72) Inventors: Nitin Ranjan, Saint Petersburg, FL (US); Aishwarya Yalamarty, Franklin, WI (US); Alain F. Bouvet, Lyon (FR)

(73) Assignee: Elutions IP Holdings S.à.r.l., Luxembourg (LU)

(21) Appl. No.: 15/707,919

(22) Filed: Sep. 18, 2017

(51) Int. Cl. G01D 4/00; B60H 1/00; G01D 4/16

(52) U.S. Cl. CPC G01D 4/004; G01D 4/18; G01D 4/16; B60H 1/00585

(57) ABSTRACT

Systems and methods for displaying resource savings. A system may comprise at least one computer-readable storage medium storing executable instructions, and at least one processor programmed by the executable instructions to present a visual representation of resource savings that are attributable to one or more consumption reduction measures. The visual representation may comprise at least one first column representing baseline resource consumption for a reporting period, at least one second column representing actual resource consumption during the reporting period, and a horizontal band intersecting the at least one first column, wherein a height of the horizontal band corresponds to a difference between a height of the at least one first column representing baseline resource consumption for the reporting period and a height of the at least one second column representing actual resource consumption during the reporting period.

### RELATED APPLICATIONS

This application is filed on the same day as International Application No. PCT/US2017/______, entitled “SYSTEMS AND METHODS FOR MANAGING RESOURCE CONSUMPTION,” bearing Attorney Docket No. E0533.70000WO00, and International Application No. PCT/US2017/______, entitled “SYSTEMS AND METHODS FOR CONFIGURING DISPLAY LAYOUT,” bearing Attorney Docket No. E0533.70002WO00. Each of these applications is hereby incorporated by reference in its entirety.

BACKGROUND

Increasingly, both public and private enterprises rely on computer systems to monitor and control resource consumption of various equipment such as heating, ventilation, and air conditioning (HVAC), refrigeration, lighting, and/or mechanical load. These computer systems process vast amounts of data (e.g., sensor data received in real time from individual assets) to identify opportunities for resource conservation. For example, a recommendation may be made to operate an asset in a different manner, so that less energy may be used while maintaining a certain level of service. Such a recommendation may be implemented automatically, or may be reviewed and approved by a human user prior to implementation.

An effective consumption management system may significantly reduce an enterprise's environmental footprint, as well as operating costs.

### SUMMARY OF INVENTION

In some embodiments, a system may be provided, comprising at least one computer-readable storage medium storing executable instructions and at least one processor programmed by the executable instructions to present a visual representation of resource savings that are attributable to one or more consumption reduction measures. The visual representation comprises at least one first column representing baseline resource consumption for a reporting period, at least one second column representing actual resource consumption during the reporting period, and a horizontal band intersecting the at least one first column, wherein a height of the horizontal band corresponds to a difference between a height of the at least one first column representing baseline resource consumption for the reporting period and a height of the at least one second column representing actual resource consumption during the reporting period.

In some embodiments, a method may be provided, as performed by the above system.

In some embodiments, at least one computer-readable storage medium storing computer-executable instructions may be provided. The computer-executable instructions, when executed, cause at least one processor to perform the method that is performed by the above system.

In some embodiments, a method for adjusting a baseline resource consumption may be provided, where the adjustment is associated with at least one incident impacting resource consumption during a reporting period. The method comprises acquiring resource consumption data from one or more resource consumption sub-meters for a plurality of time points during the reporting period, establishing a first resource consumption value based on resource consumption data associated with time points during the reporting period prior to occurrence of at least one incident, establishing a second resource consumption value based on resource consumption data associated with time points during the reporting period subsequent to occurrence of the at least one incident, determining an amount of reduction or increase in resource consumption attributable to the at least one incident based on a comparison between the first resource consumption value and the second resource consumption value, and applying an adjustment based on the determined amount of reduction or increase to a baseline resource consumption corresponding to one or more time points subsequent to the occurrence of the at least one incident in the reporting period to produce a reporting period baseline consumption.

In some embodiments, a system comprising at least one computer-readable storage medium storing computer-executable instructions may be provided. The computer-executable instructions, when executed, cause at least processor to perform the above method for adjusting a baseline resource consumption.

In some embodiments, at least one computer-readable storage medium storing computer-executable instructions may be provided. The computer-executable instructions, when executed, cause at least one processor to perform the above method for adjusting a baseline resource consumption.

### BRIEF DESCRIPTION OF DRAWINGS

FIG. 1 shows an illustrative consumption management system 100, in accordance with some embodiments.

FIGS. 2A-2B show, respectively, an illustrative virtual meter 210 and an illustrative virtual meter 252, in accordance with some embodiments.

FIGS. 3A-3F show an illustrative object tree 300 for organizing resource consumption data, in accordance with some embodiments.

FIG. 4 shows an illustrative state transition diagram 400 for a consumption management event, in accordance with some embodiments.

FIG. 5 shows an illustrative process 500 for calculating savings in resource consumption, in accordance with some embodiments.

FIG. 6 shows an illustrative plot 600 of resource consumption against a variable of interest, in accordance with some embodiments.

FIG. 7 shows an illustrative plot 700 of resource consumption against time, in accordance with some embodiments.

FIG. 8 shows an illustrative waterfall chart 800 that visually explains how savings are calculated, in accordance with some embodiments.

FIGS. 9A-9C show illustrative graphical user interfaces (GUIs) 900, 901, and 910 that depicts how elements that are within or outside the scope of the resource consumption baseline are identified and integrated into resource consumption calculations, in accordance with some embodiments.

FIGS. 10A-10B show illustrative GUIs 1000 and 1010 that depict imported data relating to variables that routinely impact resource consumption, in accordance with some embodiments.

FIG. 11 shows an illustrative GUI 1100 that depicts how routine adjustments and associated statistical analysis techniques are configured, in accordance with some embodiments.

FIG. 12 shows an illustrative GUI 1200 that depicts how load types are defined and non-routine adjustments are associated with the load types, in accordance with some embodiments.

FIG. 13 shows an illustrative GUI 1300 that depicts how non-routine adjustment analysis is performed, in accordance with some embodiments.

FIG. 14 shows an illustrative GUI 1400 that depicts how certain non-routine adjustments can be identified and analyzed for multiple sites, in accordance with some embodiments.

FIGS. 15A and 15B show illustrative GUIs 1500 and 1510 that depicts how missed savings are determined and presented, in accordance with some embodiments.

FIG. 16A shows an illustrative template used for report generation, in accordance with some embodiments.

FIG. 16B shows an illustrative customized report, in accordance with some embodiments.

FIGS. 17A-17B show illustrative GUIs 1700 and 1710 that depict non-routine adjustments for the baseline period and reporting period, respectively, in accordance with some embodiments.

FIGS. 18-19 show illustrative GUIs 1800 and 1900 that depict dynamically updated grid portions, in accordance with some embodiments.

FIG. 20 shows, schematically, an illustrative computer 10000 on which any aspect of the present disclosure may be implemented.

### DETAILED DESCRIPTION

The inventors have recognized and appreciated various technical challenges in building a consumption management system.

For instance, the inventors have recognized and appreciated that some consumption management systems are designed to monitor and control specific types of equipment (e.g., HVAC, refrigeration, lighting, mechanical load, etc.). Such a system may be able to handle only a certain type of input data (e.g., operating parameters of HVAC equipment), and it may be impractical to extend such a system to handle another type of input data (e.g., operating parameters of mechanical equipment). As a result, an enterprise that operates different types of equipment may have to use disparate consumption management systems.

The inventors have recognized and appreciated that it may be desirable to provide a more scalable consumption management system. Accordingly, in some embodiments, techniques may be provided for modeling various types of equipment in a unified manner. For instance, techniques may be provided for processing and storing data from multiple, disparate sources in a unified manner. One or more of these techniques may allow a consumption management system to be deployed in any vertical (e.g., telecommunication, cloud computing, retail, public utility, education, hospitality, manufacturing, transportation, etc.) to manage any type of resource consumption (e.g., electricity, gas, water, etc.).

The inventors have further recognized and appreciated that some consumption management systems provide recommendations without quantifying expected benefits. As a result, there may be little guarantee that resource consumption would actually be reduced by implementing a recommendation. Moreover, even if resource consumption would be reduced by implementing a recommendation, there may be no indication of how much reduction could be expected. Without such information, a user may not be able to make an informed decision on whether to implement the recommendation.

Accordingly, in some embodiments, techniques are provided for quantifying expected cost savings associated with a proposed measure to manage consumption. The inventors have recognized and appreciated that it may be efficient to identify opportunities to reduce consumption and simultaneously calculate expected cost savings. For instance, in some embodiments, a rules engine may apply one or more rules to identify opportunities to reduce consumption, and may output proposed measures for reducing consumption, along with estimated cost savings. In this manner, a user may be able to make informed decisions on whether to implement the proposed measures. Furthermore, in some embodiments, actual savings may be determined after one or more proposed measures have been implemented, and may be compared with the estimated savings output by the rules engine. This comparison may be used to adapt one or more rules used by the rules engine (e.g., using one or more machine learning techniques), so that more accurate estimates of savings may be produced in the future.

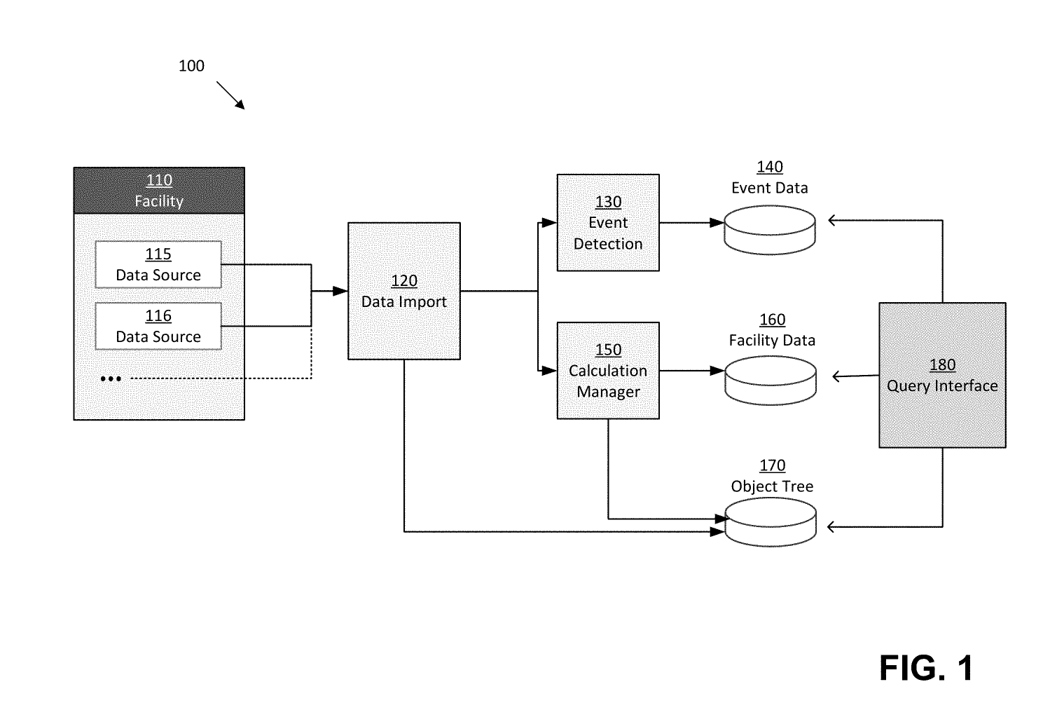

FIG. 1 shows an illustrative consumption management system 100, in accordance with some embodiments. In the example of FIG. 1, the consumption management system 100 imports data from data sources 115, 116, . . . of a facility 110. The consumption management system may check, correct, perform calculations on, and/or otherwise process the imported data to produce structured data that may be readily accessed via a query interface 180, which may include an application programming interface (API) and/or a user interface. For instance, in some embodiments, a query engine may be provided for querying one or more databases in the consumption management system 100.

In some embodiments, the consumption management system 100 may maintain one or more data stores. As an example, the consumption management system 100 may maintain an object tree 170, which may be a hierarchical data structure for organizing data in a logical manner that facilitates rapid retrieval. As another example, the consumption management system 100 may maintain a facility data store 160, which may include data assembled from various data sources, such as data imported from the data sources 115, 116, . . . , and/or one or more quantities derived from the imported data. As yet another example, the consumption management system 100 may maintain an event data store 140, which may indicate, based on the imported data, identified resource consumption recommendations with associated quantified expected benefits. As explained further below, the inventors have recognized and appreciated various benefits provided by maintaining data stores such as the object tree 170, the facility data store 160, and/or the event data store 140. However, it should be appreciated that aspects of the present disclosure are not limited to the use of any particular one of these data stores.

In some embodiments, the consumption management system 100 may be hosted on one or more computing devices that are located remotely from the facility 110. For instance, the consumption management system 100 may receive data from the data sources 115, 116, . . . via one or more networks (e.g., the Internet). In some embodiments, one or more communications to and/or from the consumption management system 100 may be encrypted to protect privacy. For example, a secure tunnel may be established between the consumption management system 100 and a local network at the facility 110 (e.g., using a virtual private network technology). However, it should be appreciated that aspects of the present disclosure are not limited to the use of any secure tunnel. For instance, in some embodiments, one or more components of the consumption management system 100 may be hosted on one or more computing devices on a local network at the facility 110.

In the example of FIG. 1, the facility 110 may be a site operated by an enterprise (e.g., utility company, healthcare organization, university, cloud computing provider, retail chain, etc.), and may include one or more parts of a building, an entire building, and/or a plurality of buildings where one or more pieces of energy consuming equipment may be located. For instance, the facility 110 may include a water treatment plant, a hospital, a university campus, a data center, a grocery store, a factory, a bakery, a farm, etc. The data sources 115, 116, . . . may provide various types of data collected from the facility 110. Such data may be indicative of one or more aspects of operation of the facility 100.

Although not shown in FIG. 1, the consumption management system 100 may, in some embodiments, receive data from one or more facilities other than the facility 110. Each such facility may be operated by a same enterprise or different enterprises, and may include any suitable combination of one or more data sources.

In some embodiments, a data source may include a sensor installed at the facility 110. The sensor may obtain data from an environment at the facility 110, and may produce data indicative of that environment. Examples of sensors include, but are not limited to, an electrical load sensor, temperature sensor, motion sensor, air flow meter, chemical detector (e.g., ozone monitor, carbon monoxide detector, etc.), current detector, voltage detector, hygrometer, barometer, etc., and suitable combinations thereof. It will be appreciated that such a sensor may be coupled to equipment having one or more properties that are sensed by the sensor. For instance, an electrical load sensor may be coupled to an electrical meter, and may read an electrical load present within the meter and produce data indicative of said load.

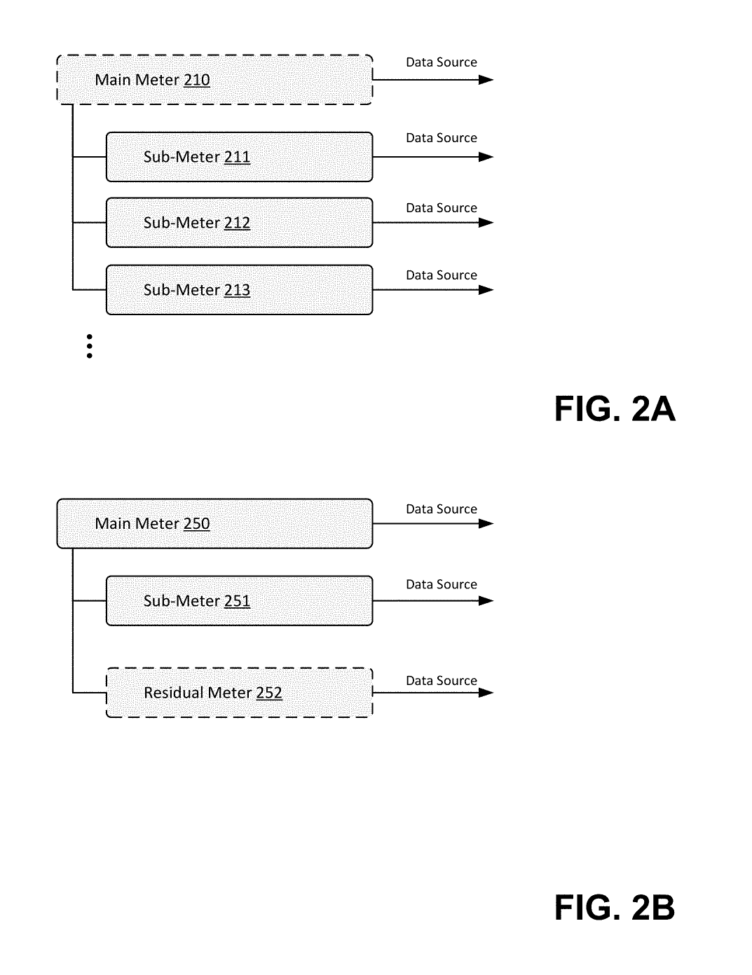

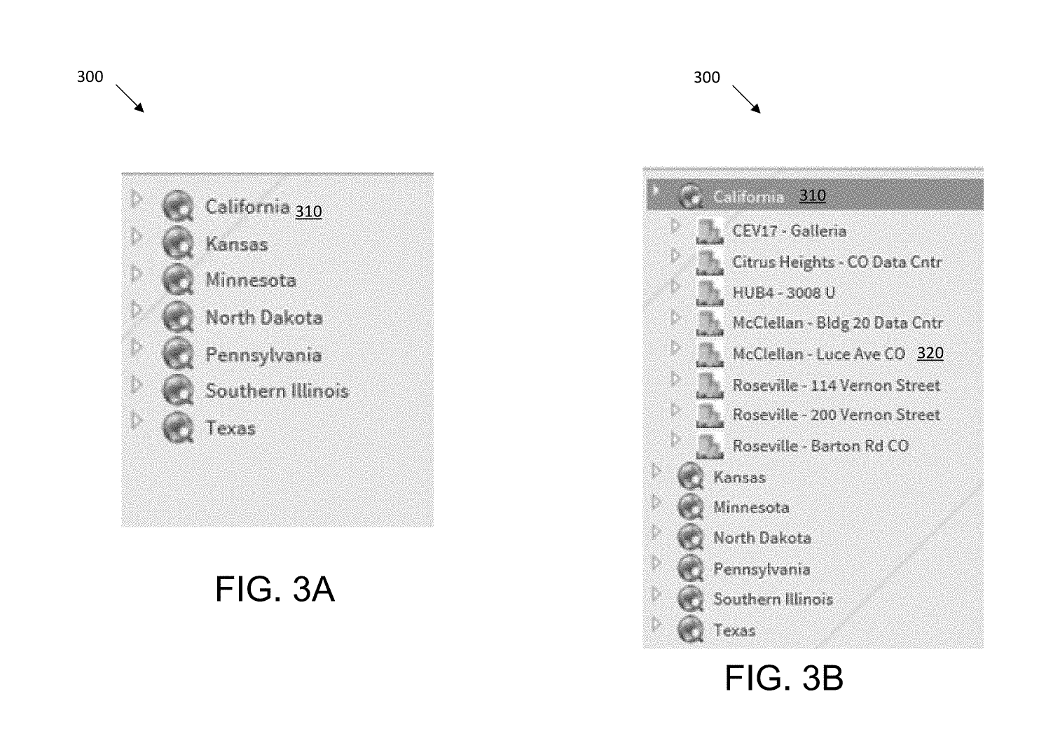

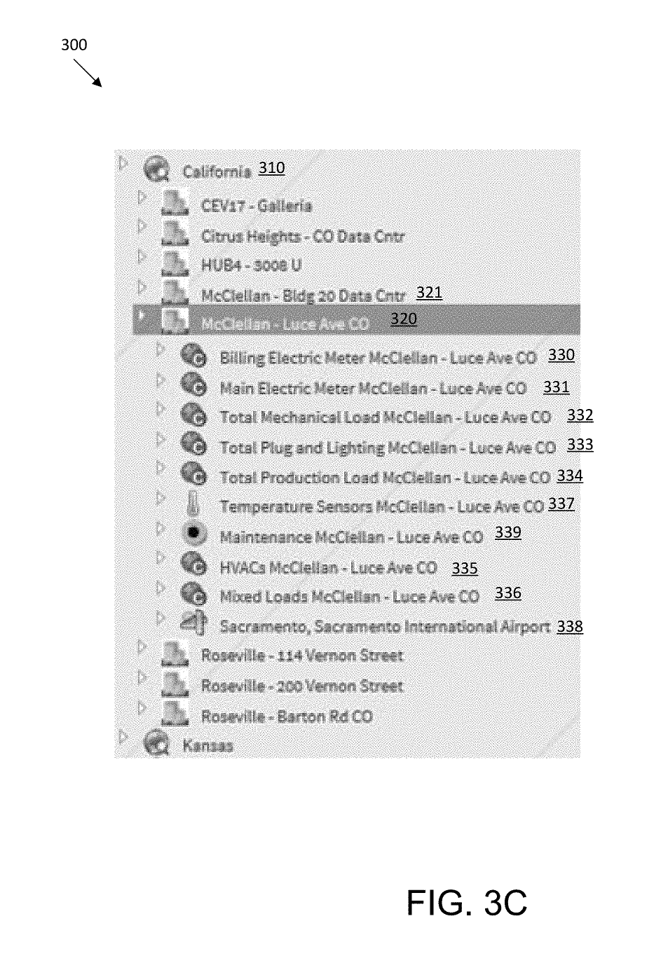

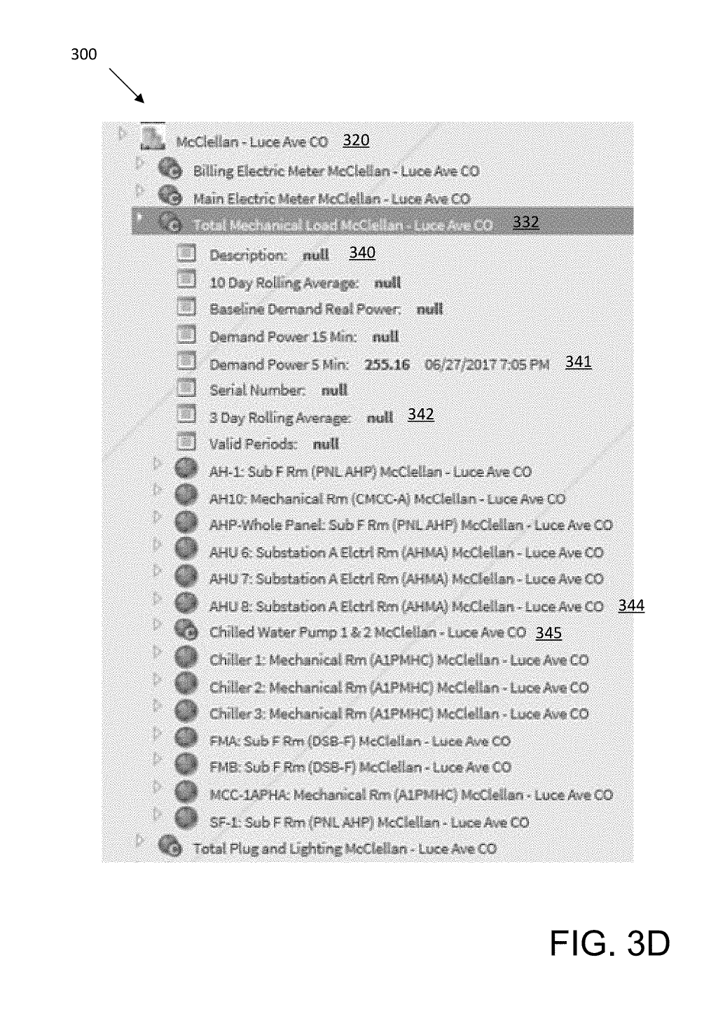

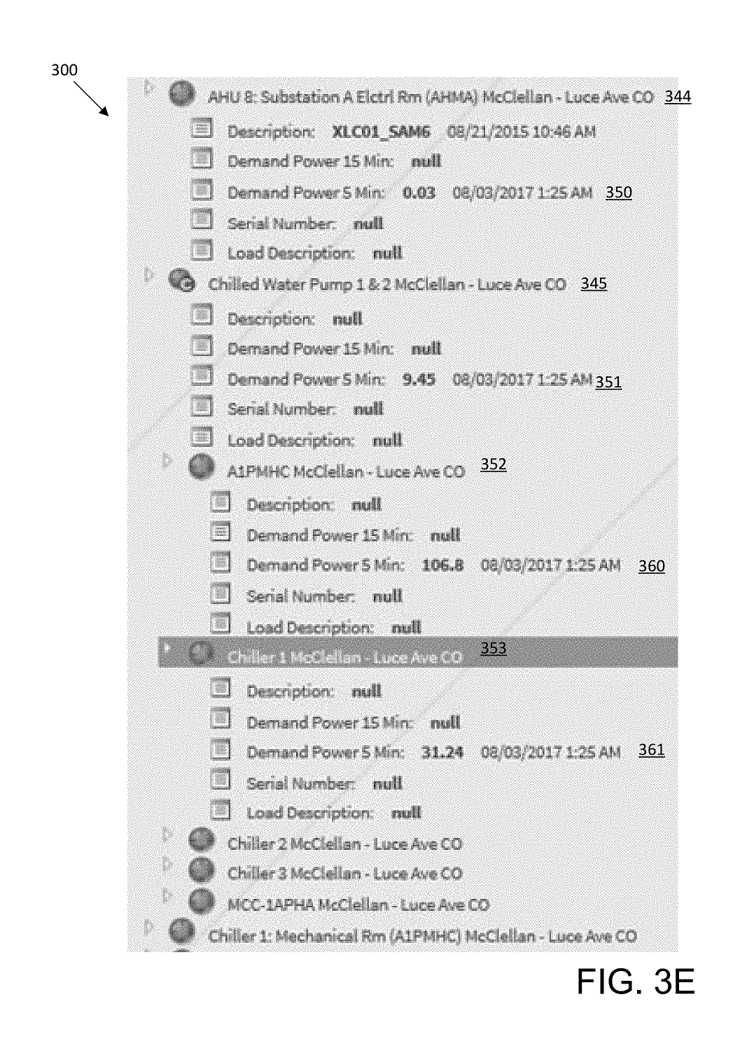

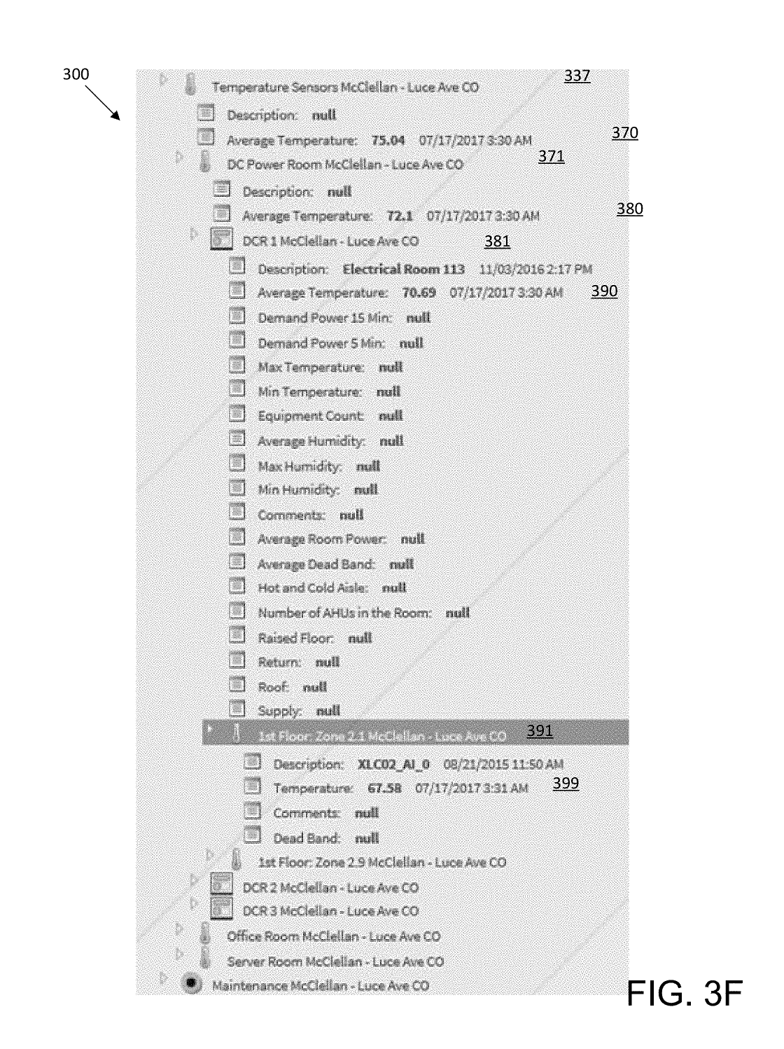

The inventors have recognized and appreciated that availability of more data may provide a fuller picture of what is happening at a facility. This may allow a consumption management system to perform analysis in a more fine grained manner, which may in turn lead to improved energy efficiency. However, the inventors have also recognized and appreciated that over-instrumentation may be costly, and may increase data volume and/or complexity. Increased data volume and/or complexity may prevent a consumption management system from performing certain analyses in real time, which may delay recommendations that would have reduced resource consumption. Accordingly, in some embodiments, sensors may be deployed in a structured manner to facilitate efficient processing and/or storage of data. Examples of structured deployment of sensors are discussed below in connection with FIGS. 2B, 3A-3F.

In some embodiments, the facility 110 may include one or more computing devices configured to interface with, respectively, one or more of the data sources 115, 116, . . . . For instance, the data sources 115, 116, . . . may produce data in differing formats and/or transmit data using differing protocols. Examples of native formats include, but are not limited to, Comma Separated Values (CSV) files, Remote Terminal Unit (RTU) data, etc. Examples of protocols include, but are not limited to HTTP, HTTPs, TCP/IP, serial communication protocols, BACnet, Modbus TCP/IP, etc. Accordingly, a computing device at the facility 110 may execute selected driver software, and/or include selected hardware, to receive and/or appropriately interpret data from a certain data source.

In some embodiments, a plurality of drivers may process native data from, respectively, a plurality of data sources that utilize different data formats and/or different transmission protocols, and may produce data having a common format (e.g., a data record format containing multiple data fields), for example, using appropriate interface protocols. Thus, the drivers may convert native data from disparate sources into standardized data, which may be more readily consumed by the consumption management system 100. In this manner, the consumption management system 100 may be programmed to execute on incoming data irrespective of how, or by what device, the data was produced. Such an approach may reduce a need for the consumption management system 100 to perform specialized data handling, which in turn may allow the consumption management system 100 to be deployed for any resource type, any enterprise, and/or any vertical.

In the example of FIG. 1, the consumption management system 100 includes a data import module 120, an event detection module 130, and a calculation manager module 150. Any one or more of these modules may be executed by one or more computing devices at the facility 110, or at a different physical location. For instance, in some embodiments, a server (or a cluster of servers) may execute the modules 120, 130, and 150.

In some embodiments, the data import module 120 may be programmed to cleanse data received from the data sources 115, 116, . . . . For instance, the data import module 120 may be programmed to check and/or correct incoming data to ensure that data passed to one or more downstream modules meets some appropriate standard of validity. As an example, a data validity check may comprise application of one or more appropriate validity rules to determine whether a valid data value is provided for a data field. Examples of validity rules include, but are not limited to, rules relating to expected data type, expected data range (e.g., temperature values below −50° C., a weight less than zero, a negative power demand, a value that is more than some number, say, 10, standard deviation away from a rolling average such as a 3-day average or a 10-day average, etc., may be considered invalid), presence of expected data values, sudden change in data values (e.g., increase between consecutive samples larger than certain threshold, say, 200%, may be considered invalid), etc., and suitable combinations thereof.

In some embodiments, the data import module 120 may be programmed to take one or more corrective actions in response to identifying an invalid or missing data value (also referred to herein as a “defect”). As one example, an invalid or missing data value in a data field may be addressed by contacting an appropriate data source and attempting to correct or recover the data value, if possible. As another example, an invalid or missing data value in a data field may be addressed using a selected constant value for that data field (e.g., some nominal value for the data field). As another example, an invalid or missing data value in a data field may be addressed using a value produced by interpolating (or otherwise predicting from) other data values of the same data field (e.g., from one or more data values produced earlier and/or one or more data values produced later).

As another example, an invalid or missing data value may be addressed using an historically-appropriate value based on an expectation that the data value would have, if present and valid, been similar to historical observations. For instance, an invalid or missing data value may be addressed using a data value obtained for the same data field at an earlier time, such as the same time a day earlier, or a week earlier. In some embodiments, an historically-appropriate value may be used, in some embodiments, only when certain conditions are met, such as when the earlier time was similar in some manner to a time of the invalid or missing data value based on one or more external factors (e.g., correct a resource consumption data value with a historical data value only when the weather is similar on both days). For instance, a linear regression expression on degree days or opening hours may be used, or a previous time period may be selected that has similar conditions (e.g., no more than a maximum allowed difference for each correlated parameter).

It should be appreciated that aspects of the present disclosure are not limited to taking any particular type of corrective action, or any corrective action at all. In some embodiments, an appropriate corrective action may be selected based on one or more factors, such as a type of a data field exhibiting a defect and/or a type of the defect.

In the example of FIG. 1, the data import module 120 is programmed to populate one or more hierarchical data structures, such as the object tree 170, based on data received from the data sources 115, 116, . . . . The inventors have recognized and appreciated that, while one or more databases may be used to store the received data, database queries may be slow, which may negatively impact response time of the consumption management system 100. For instance, when a user requests certain information (e.g., average daily resource consumption over a certain past period of time for a certain load type, such as refrigeration, in a certain geographical region), the consumption management system 100 may query one or more databases to retrieve relevant data (e.g., hourly consumption values for individual refrigeration units in all sites in the specified geographical region within the specified period of time), and perform one or more calculations on retrieved data to provide the requested information (e.g., aggregating hourly consumption values for individual refrigeration units into daily consumption values, then aggregating across all refrigeration units at each site, then aggregating across all sites in the specified geographical region, and then averaging over the specified period of time). It may take the consumption management system 100 quite some time to respond (e.g., several seconds or tens of seconds) due to a large number of database queries and/or calculations that may be performed. Accordingly, in some embodiments, a hierarchical data structure may be used organize data in a manner that facilitates rapid retrieval.

The inventors have recognized and appreciated certain commonalities in how resources are consumed across different enterprises in different verticals. For instance, regardless of which vertical an enterprise is in, the enterprise may include one or more sites, which may be grouped by geographical location (e.g., country, region, state, county, city, neighborhood, etc.). A site may consume one or more types of resources (e.g., gas, electricity, water, etc.), and may include one or more buildings. A building may house one or more pieces of resource consuming equipment, which may be grouped based on load type (e.g., lighting, refrigeration, HVAC, mechanical load, etc.). A piece of resource consuming equipment (also referred to herein as an “asset”) may have one or more associated properties, such as a static property (e.g., name, serial number, installation date, etc.), a dynamic property (e.g., for a boiler, supply temperature, return temperature, set point, demand power, etc.), and/or a derived property (e.g., cumulative energy consumption in current day, week, month, year, or some other suitable period). Thus, in some embodiments, a hierarchical data structure, such as the object tree 170 in the example of FIG. 1, may be used to model resource consumption within an enterprise, regardless of which vertical the enterprise is in.

The inventors have recognized and appreciated that a hierarchical data structure may be accessed more efficiently than a database. Furthermore, the inventors have recognized and appreciated that a derived property of an asset may be updated as relevant data is received through the data import module 120. In this manner, a most up-to-date value of the derived property may always be available, so there may be no need to calculate such a value when a user request is received. One or both of these techniques (i.e., hierarchical data structure and/or derived property) may be used to reduce response time of the consumption management system 100. However, it should be appreciated that neither technique is required.

In the example of FIG. 1, the calculation manager module 150 may be programmed to perform one or more calculations based on data values received from the data import module 120, and to store results of said calculations in the facility data store 160. Additionally, or alternatively, the calculation manager module 150 may store results of calculations in the object tree 170. For instance, in some embodiments, the calculation manager module 150 may calculate a most up-to-date value of a derived property of an asset in the object tree 170, as discussed above. Additionally, or alternatively, the calculation manager module 150 may perform aggregations by traversing the object tree 170 (e.g., aggregating consumption of all refrigeration units within a building, site, region, etc.).

The calculation manager module 150 may be programmed to calculate any suitable type of derived quantity. For instance, the calculation manager module 150 may be programmed to evaluate a function of one or more data fields. This may include accessing current values of the one or more data fields, and performing one or more arithmetic operations on those values and/or one or more constant values. For instance, a derived quantity Q may be calculated by the calculation manager module 150 as:

Q=0.3×(Value of Data Field A)+(Value of Data Field B).

In some embodiments, a data field value used by the calculation manager module 150 to calculate a derived quantity may itself also be a derived quantity. For instance, a derived normalized electricity consumption value may be calculated by the calculation manager module 150 by dividing a data value indicating electricity consumption for a given physical space by a data value indicating a size of the physical space (e.g., producing a value in units of kWh/m2), where the data value indicating electricity consumption for the physical space may itself be calculated by the calculation manager module 150 as a sum of electricity consumption of all electrical appliances located in the physical space.

The inventors have recognized and appreciated that the calculation manager module 150 may be used, in some embodiments, to ensure that certain performance indicators (such as the normalized electricity consumption value discussed above) are constantly (or periodically) updated as new data arrives, so that most up-to-date values of the performance indicators are always readily available. This may reduce response time of the consumption management system 100 by reducing on-the-fly calculations when a user requests such performance indicators (e.g., to determine how efficiently aspects of an enterprise's operation are functioning).

In some embodiments, the calculation manager module 150 may be programmed to calculate and/or store historical data for one or more data fields. For instance, it may be desirable to track data values produced by one or more of the data sources 115, 116, . . . over a period of time (e.g., past week, month, year, etc., or some other suitable period). Such data values may be stored in the facility data store 160 as received from the data import module 120. Additionally, or alternatively, derived data values may be calculated and stored as historical data. For example, the calculation manager module 150 may access hourly values of electricity consumption recorded within a past week for a given physical space, and may sum those values to yield a cumulative consumption value for the past week. The cumulative consumption value (which may be stored as a derived quantity, or merely utilized in a present calculation) may be divided by 7 (representing days in a week), and by a data value indicating a size of the physical space, to produce a normalized daily average consumption value (e.g., in units of kWh/Day/m2).

In the example of FIG. 1, the event detection module 130 is programmed to compare received data values with predetermined set points to determine whether an anomaly has occurred. In some embodiments, a set point may represent a desired operating state of an asset. For instance, the set point may be chosen to improve resource utilization. An anomaly may be triggered if the asset is programmed to operate above (or below) the set point. When an anomaly is identified, an event is generated in event data 140, which comprises information about the anomalous event.

As referred to herein, an anomaly encompasses any observance of one or more data values that are in some way unexpected given historical or otherwise anticipated values of the relevant data fields. Any number of set points for a data field may be set based on such expectations so that, if values of the data field deviate from the defined set point(s), event detection module 130 may produce an event comprising details about said deviation. Multiple types of anomalies and therefore multiple set points may be set for a given data field or combination of data fields. For example, a data field representing a water flow rate through a pump may have a set point set so that if the water flow rate falls to zero (or close to zero), event detection module 130 may generate an event indicating that the pump may be inoperable. In addition, a set point may be set for the same data field as a range of water flow rates that represent nominal flow values for the pump. If the water flow rate is measured to be outside of this range, event detection module 130 may generate an event indicating an anomaly in the water flow rate that is different from the event indicating a potentially inoperable pump.

According to some embodiments, the event detection module 130 executes a rules engine that examines incoming data values to determine what occurred that gave rise to the anomaly whilst also calculating cost savings associated with correction of the anomaly. The rules engine may be configured based on expected cost savings for a particular customer so that the conditions that, when evaluated, determine that an anomaly has occurred also calculate expected cost savings associated with correction of the anomaly based on these conditions. For instance, based on the above example of a water pump, when the rules engine determines that the water flow rate has fallen to zero, the expected savings may be simultaneously calculated based on the expected cost of replacing or repairing the water pump, whereas when the rules engine alternatively determines that the water flow rate is measured to be outside of the range set point, the expected savings may be simultaneously calculated based on how much money would be saved were the water flow rate adjusted to be within the range. In the latter case, calculations of expected savings may, for example, take into account expected effects on other parts of the facility that are causally linked with the water pump (e.g., up- or downstream parts), costs of performing adjustments on the system, expected changes in lifetime of the pump, etc.

In the example of FIG. 1, the query interface 180 may be programmed to access the object tree 170, the facility data store 160, and/or the event data store 140. For instance, the query interface 180 may include a query API that may be used by other components of the consumption management system 100 to run queries against stored data.

In some embodiments, the query interface 180 may include one or more user interfaces configured to allow a user to browse some or all of the stored data. For instance, the query interface 180 may include a web-based thin client programmed to provide various user interfaces via a web browser. A web server may formulate a query based on user input received via the web browser and one or more networks, issue the query via the query API, and transmit a result of the query to the web browser via the one or more networks. The web browser may present the result to the user. Additionally, or alternatively, the query interface 180 may include a mobile device app programmed to provide various user interfaces. The mobile device app may formulate a query based on user input, transmit the query via one or more networks to the query API, receive a result of the query via the one or more networks, and present the result to the user.

In some embodiments, access to the object tree 170, the facility data store 160, and/or the event data store 140 may be controlled via one or more suitable access control mechanisms. For instance, a first enterprise may have multiple facilities. A user at a certain facility may be granted access only to data pertaining to that facility, whereas a user at a headquarters may be granted access to data pertaining to all facilities within the first enterprise. On the other hand, a user from a second enterprise may be granted access only to data pertaining to the second enterprise, and may not be granted access to any data pertaining to the first enterprise.

Although various details of implementation are shown in FIG. 1 and discussed above, it should be appreciated that aspects of the present disclosure are not limited to the use of any particular component, or combination of components, or to any particular arrangement of components. For instance, it should be appreciated that the object tree 170, the facility data store 160, and/or the event data store 140 may be stored within a same database, in any number of different databases, or represented in any other suitable manner, such as by storing data in flat files (e.g., XML files). Furthermore, each component may be implemented in any suitable manner, such as using one or more parallel processors operating at a same location or different locations.

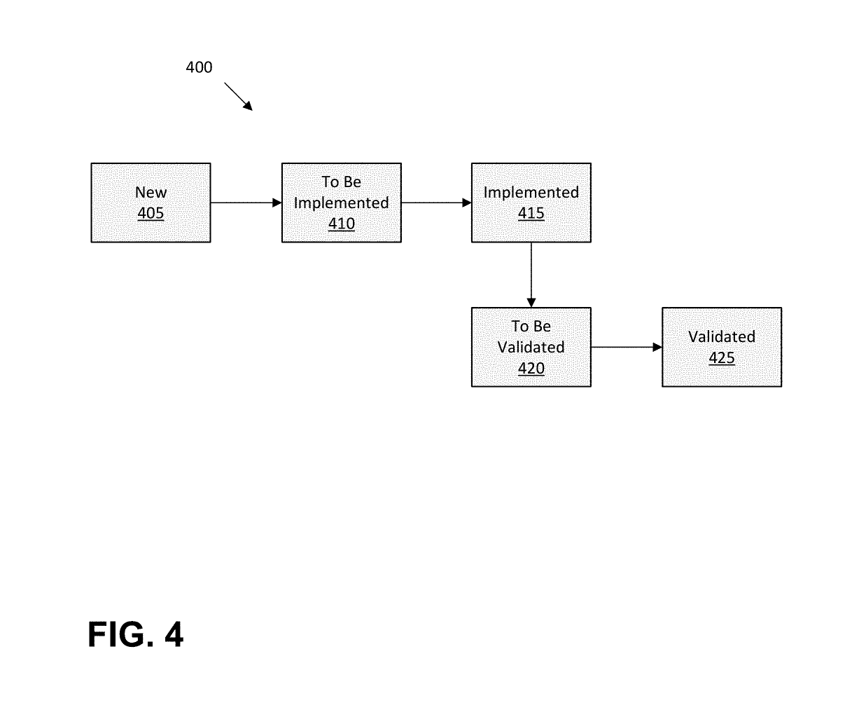

FIGS. 2A-2B show, respectively, an illustrative virtual meter 210 and an illustrative virtual meter 252, in accordance with some embodiments. In the example of FIG. 2A, a sensor may be installed at each of a plurality of lighting units to measure electricity consumption of that unit. These sensors may correspond, respectively, to sub meters 211, 212, 213, . . . shown in FIG. 2A. A virtual lighting meter, shown as main meter 210 in FIG. 4A, may be obtained by summing electricity consumption measurements from the individual lighting units. In some embodiments, values provided by the virtual lighting meter may be stored in an object tree, as discussed in detail in connection with FIGS. 3A-3F.

In the example of FIG. 2B, an electric panel may serve a refrigeration unit and multiple lighting units. A first sensor may be installed to measure electricity consumption of the electric panel (i.e., combined electricity consumption of the refrigeration unit and the multiple lighting units), and a second senor may be installed to measure electricity consumption of the refrigeration unit alone. The first and second sensors may correspond, respectively, to main meter 250 and sub meter 251 shown in FIG. 2B. A virtual lighting meter, shown as residual meter 252 in FIG. 2B, may then be obtained by subtracting the refrigeration unit's electricity consumption measurement from the combined consumption measurement. However, it should be appreciated that aspects of the present disclosure are not limited to the use of a virtual meter to obtain a consumption value, as in some embodiments a site may have a main switch board feeding all equipment of a certain type (e.g., mechanical, lighting, etc.), and a sensor may be installed at the main switch board to obtain a consumption value for that equipment type.

In some embodiments, a virtual data source (e.g., the illustrative virtual meter 210 in the example of FIG. 2A, or the illustrative virtual meter 252 in the example of FIG. 2B) may be calculated by one or more computing devices located at a facility (e.g., executing appropriate driver software). Alternatively, or additionally, a virtual data source may be calculated by a component of a consumption management system (e.g., the illustrative calculation manager module 150 in the example of FIG. 1), which may execute on one or more computing devices located remotely from the facility.

The inventors have recognized and appreciated that virtual data sources may be used to provide flexibility in how data is collected and/or analyzed. For instance, in the example of FIG. 2B, there may be a large number of individual lighting units, and it may be costly to install a sensor at each lighting unit. Therefore, it may be more cost effective to measure the combined electricity consumption of the refrigeration unit and the multiple lighting units, and then subtract the electricity consumption of the refrigeration unit, even though the combined electricity consumption measurement, by itself, may be not useful to a consumption management system (e.g., because the combined electricity consumption measurement mixes two different consumption categories, refrigeration and lighting). Moreover, the use of a virtual data source may improve transparency. For instance, a component of a consumption management system that uses a virtual data source may be unaffected by changes in how the virtual data source is implemented. However, it should be appreciated that aspects of the present disclosure are not limited to the use of a virtual data source.

FIGS. 3A-3F show an illustrative object tree 300 for organizing resource consumption data, in accordance with some embodiments. For instance, the object tree 300 may be a portion of the illustrative object tree 170 in the example of FIG. 1, and may be used to model resource consumption within an enterprise.

As discussed above, the inventors have recognized and appreciated certain commonalities in how resources are consumed across different enterprises in different verticals. The inventors have further recognized and appreciated that these commonalities may be exploited to provide a hierarchical structure that may be easily adapted for any enterprise in any vertical. For instance, an enterprise may operate one or more sites, which may be grouped by geographical region. Accordingly, in the example of FIG. 3A, the object tree 300 includes a plurality of nodes corresponding respectively to different geographical regions, such as a node 310 corresponding to California. In some embodiments, each node corresponding to a geographical region may have one or more child nodes corresponding, respectively, to different sites located in that region. For instance, in the example of FIG. 3B, the node 310 has a plurality of child nodes corresponding, respectively, to different sites located in California, such as a node 320 corresponding to a site named “McClellan—Luce Ave CO.”

The inventors have recognized and appreciated that sites within the object tree 300 may be organized in a manner that matches an enterprise's organizational structure (e.g., grouped by geographical region), so that a user already familiar with the enterprise's organizational structure may be able to quickly find a site within the object tree 300. However, it should be appreciated that aspects of the present disclosure are not limited to grouping sites in any particular manner, or any grouping at all. For instance, in some embodiments, one or more sites may be found at a top level of an object tree (e.g., arranged in alphabetical order based on site name).

Furthermore, in some embodiments, a corporate branch within the enterprise's organizational structure may include multiple buildings or multiple groups of buildings, each of which may be represented by a different node in the object tree. For instance, in the example shown in FIG. 3C, the node 320 (“McClellan—Luce Ave CO”) and a node 321 (“McClellan—Bldg 20 Data Cntr”) may represent, respectively, different buildings at a same corporate branch (“McClellan”).

As discussed in connection with FIG. 1, the inventors have recognized and appreciated that a hierarchical data structure such as the object tree 300 shown in FIGS. 3A-3F may be used to organize information and facilitate rapid retrieval. Accordingly, in some embodiments, the node 320 (“McClellan—Luce Ave CO”) may have a plurality of child nodes representing different types of information of interest. For instance, there may be a “Billing Electric Meter” node 330 and a “Main Electric Meter” node 332 corresponding, respectively, to electricity consumption at the site “McClellan—Luce Ave CO” as reported by a meter connected to a system of a resource provider (e.g., a utility company), and by a meter connected to a system of an enterprise operating the site or a consumption reduction service provider.

The inventors have recognized and appreciated it may be beneficial to break down total resource consumption into different categories based on a purpose for which resource is consumed (e.g., lighting, refrigeration, HVAC, mechanical load, etc.). This may allow a user to gain deeper insight into how resources are consumed, and to make different decisions for different categories of consumption. Accordingly, in the example of FIG. 3C, the node 320 (“McClellan Luce Ave CO”) has a plurality of child nodes corresponding, respectively, to different load categories. For instance, there may be a “Total Mechanical Load” node 332 corresponding to consumption by mechanical equipment, a “Total Plug and Lighting” node 333 corresponding to consumption via electrical outlets, as well as consumption by lighting units, a “Total Production Load” node 334 corresponding to consumption by production equipment (e.g., assembly lines in a factory, ovens in a bakery, etc.), and an “HVACs” node 335 corresponding to consumption by HVAC equipment.

It should be appreciated that aspects of the present disclosure are not limited to tracking consumption by any particular load category, or by any load category at all. For instance, in the example of FIG. 3C, the node 320 (“McClellan—Luce Ave CO”) has a child node 336 (“Mixed Loads”) corresponding to consumption by multiple pieces of equipment belonging to different load categories. Such a node may be created for any suitable reason. As an example, there may be one physical meter measuring collective consumption by the multiple pieces of equipment, and it may be too costly to install separate meters to segregate the different load categories. As another example, a user may simply wish to track these pieces of equipment together for administrative purposes. Thus, a piece of equipment may be tracked under different child nodes of the node 320 (“McClellan—Luce Ave CO”). For instance, a same piece of mechanical equipment may be tracked under the node 336 (“Mixed Loads”), as well as the node 332 (“Total Mechanical Load”).

The inventors have further recognized and appreciated it may be beneficial to maintain data relating to one or more aspects of a site's operation. For example, such data may be used to identify opportunities to reduce resource consumption while maintaining a desired state of operation. Accordingly, in some embodiments, one or more sensors and/or interfaces to existing instruments may be installed at a site to collect measurements. Data obtained from these measurements may be stored in the object tree 300 for ready access. For instance, in the example of FIG. 3C, the node 320 has a child node 337 (“Temperature Sensors”) corresponding to temperature sensors installed at the site “McClellan—Luce Ave CO.”

It should be appreciated that aspects of the present disclosure are not limited to the use of any particular type of sensor or other instrument. In some embodiments, measurements may be collected using different types of sensors having different functionalities (e.g., for measuring temperature, humidity, pressure, etc.), and the node 320 (“McClellan—Luce Ave CO”) may have different child nodes corresponding, respectively, to the different types of sensors (e.g., a temperature sensors node, a humidity sensors node, a pressure sensors node, etc.). However, it should be appreciated that aspects of the present disclosure are not limited to grouping sensors and/or other instruments by functionality, as any other suitable grouping may be used, or no grouping at all.

The inventors have further recognized and appreciated it may be beneficial to maintain data relating to one or more variables that may impact resource consumption. For example, such data may be used to accurately determine savings resulting from implementing one or more consumption reduction measures. Accordingly, in some embodiments, the node 320 may have different child nodes corresponding, respectively, to different types of variables that may impact resource consumption at the site “McClellan—Luce Ave CO.” For instance, in the example of FIG. 3C, the node 320 has a child node 338 (“Sacramento—Sacramento International Airport”) corresponding to weather conditions reported by a weather station located near the site “McClellan—Luce Ave CO.” Although not shown, other types of variables (e.g., production volume, rates charged by utility companies, etc.) may be tracked in addition to, or instead of, weather.

In some embodiments, there may be a “Maintenance” node 339, which may store all data from various data sources. In this manner, a failure may be readily identified (e.g., a particular sensor that failed to provide a meaningful output).

In some embodiments, each child node of the node 320 (“McClellan—Luce Ave CO”) may have one or more associated properties, such as a static property, a dynamic property, and/or a derived property. A static property may have a value that is not expected to change over time, such as name, serial number, installation date, etc. A dynamic property may be expected to have different values over time, such as demand power. Such values may be updated continually based on information received from data sources such as the illustrative data sources 115, 116, . . . in the example of FIG. 1. A derived property may have values derived in any suitable manner, for example, based on one or more values of static properties, dynamic properties, and/or other derived properties in the object tree 300, and/or values persisted in a data store such as the illustrative facility data store 160 in the example of FIG. 1.

In the example of FIG. 3D, the node 332 (“Total Mechanical Load”) has a plurality of static properties (e.g., “Description” 340) and a plurality of derived properties (e.g., “Demand Power 5 Min” 341 and “3 Day Rolling Average” 342 of demand power). A derived property may be computed from data available from the object tree 300. However, it should be appreciated that these properties are shown and described solely for purposes of illustration, as aspects of the present disclosure are not limited to tracking any particular property.

In some embodiments, the node 332 (“Total Mechanical Load”) may correspond to a physical meter measuring consumption of all mechanical equipment at the site “McClellan—Luce Ave CO.” The inventors have recognized and appreciated that installation of such a meter may require significant electrical work (e.g., re-wiring), and therefore may be costly or even impractical. Accordingly, in some embodiments, the node 332 (“Total Mechanical Load”) may instead correspond to a virtual meter that is a sum of a plurality of sub-meters, and may have a plurality of child nodes corresponding, respectively, to the plurality of sub-meters. In the example of FIG. 3D, the node 332 (“Total Mechanical Load”) has a plurality of child nodes including a node 344 (“AHU 8: Substation A Elctrl Rm (AHMA)”) corresponding to a sub-meter for a particular room at the site “McClellan—Luce Ave CO,” and a node 345 (“Chilled Water Pump 1 & 2”) corresponding to a sub-meter for two chilled water pumps at the site “McClellan—Luce Ave CO.”

In some embodiments, the node 344 (“AHU 8: Substation A Elctrl Rm (AHMA)”) may correspond to a physical meter measuring consumption of all mechanical equipment located in the associated room, and may have one or more static, dynamic, and/or derived properties. In the example of FIG. 3E, the node 344 (“AHU 8: Substation A Elctrl Rm (AHMA)”) has a plurality of properties including a dynamic property “Demand Power 5 Min” 350, which may be updated based on data received from the physical meter corresponding to the node 344 (“AHU 8: Substation A Elctrl Rm (AHMA)”).

By contrast, in the example of FIG. 3E, the node 345 (“Chilled Water Pump 1 & 2”) corresponds to a virtual meter that is a sum of a plurality of sub-meters. Thus, in addition to a plurality of static, dynamic, and/or derived properties (e.g., a derived property “Demand Power 5 Min” 351), the node 345 (“Chilled Water Pump 1 & 2”) may have a plurality of child nodes corresponding, respectively, to the plurality of sub-meters. For instance, the node 345 (“Chilled Water Pump 1 & 2”) may have five child nodes, including a node 352 (“A1PMHC”) and a node 353 (“Chiller 1”).

In some embodiments, each child node of the node 345 (“Chilled Water Pump 1 & 2”) may have one or more static, dynamic, and/or derived properties. For instance, in the example of FIG. 3E, the node 352 (“A1PMHC”) has a plurality of properties including a dynamic property “Demand Power 5 Min” 360, which may be updated based on data received from a physical meter corresponding to the node 352 (“A1PMHC”). Likewise, the node 353 (“Chiller 1”) has a plurality of properties including a dynamic property “Demand Power 5 Min” 361, which may be updated based on data received from a physical meter corresponding to the node 353 (“Chiller 1”).

The inventors have recognized and appreciated various advantages of a hierarchical data structure such as the object tree 300 shown in FIGS. 3A-3F. For instance, the object tree 300 may be constructed to reflect a logical organization that may be intuitive to a user. In some embodiments, a user interface may be provided (e.g., by the illustrative query interface 180 in the example of FIG. 1) according to the object tree 300. Such a user interface may allow a user to easily “zoom in” from a higher level in the object tree 300 to a lower level (e.g., from region to site, to particular load category, to sub-meter, and then to physical meter or individual asset). Likewise, a user may be able to easily “zoom out” from a lower level in the object tree 300 to a higher level.

The inventors have further recognized and appreciated that a hierarchical data structure such as the object tree 300 shown in FIGS. 3A-3F may be used to facilitate aggregation of data. For instance, instead of storing raw data in a database and performing on-demand queries to aggregate data, certain statistics of interest may be stored in the object tree 300 and may be constantly or periodically updated as new data arrives. In this manner, the statistics of interest may be readily available, which may improve response time when a user requests certain information.

In some embodiments, updating a statistic may involve a traversal of the object tree 300, aggregating relevant values from leaf nodes upwards to a node of interest. As an example, to update the derived property “Demand Power 5 Min” 341 of the node 332 (“Total Mechanical Load”), demand power values may be accessed from all leaf nodes under the node 332 (“Total Mechanical Load”). For instance, demand power values may be accessed from all five child nodes of the node 345 (“Chilled Water Pump 1 & 2”), including the dynamic property “Demand Power 5 Min” 360 of the node 352 (“A1PMHC”) and the dynamic property “Demand Power 5 Min” 361 of the node 353 (“Chiller 1”). These values may be summed and stored as the derived property “Demand Power 5 Min” 351 of the node 345 (“Chilled Water Pump 1 & 2”). This may in turn be aggregated with the dynamic property “Demand Power 5 Min” 350 of the node 344 (“AHU 8: Substation A Elctrl Rm (AHMA)”), as well as demand power values from other child nodes of the node 332 (“Total Mechanical Load”), to provide a value for the derived property “Demand Power 5 Min” 341 of the node 332 (“Total Mechanical Load”).

In some embodiments, total demand power for a site may be obtained by aggregating demand power values from different load categories that are present at the site. Likewise, total demand power for a geographical region may be obtained by aggregating demand power values from different sites located in that region.

The inventors have recognized and appreciated that, when a derived property is updated, it may be beneficial to store one or more immediate results in the object tree 300. For instance, as discussed above, a sum of demand power values from all five child nodes of the node 345 (“Chilled Water Pump 1 & 2) may be stored as the derived property “Demand Power 5 Min” 351, even though an ultimate goal is to update the derived property “Demand Power 5 Min” 341 of the node 332 (“Total Mechanical Load”). In this manner, when the derived property “Demand Power 5 Min” 351 is needed for another purpose, its value may simply be looked up from the object tree 300, without having to repeat the computation already performed (unless the value has become stale). In some embodiments, a derived property may be re-computed in response to detecting and correcting an error in a data source from which the derived property depends.

Referring to FIG. 3F, the node 337 (“Temperature Sensors”) may have one or more static, dynamic, and/or derived properties (e.g., a derived property “Average Temperature” 370), and/or one or more child nodes (e.g., a “DC Power Room” node 371) corresponding, respectively, to different areas within the site “McClellan—Luce Ave CO.” Each child node may in turn have one or more static, dynamic, and/or derived properties, and/or one or more child nodes corresponding, respectively, to different sub-areas. For instance, in the example of FIG. 3F, the node 371 (“DC Power Room”) has a plurality of properties including a derived property “Average Temperature” 380, and a plurality of child nodes including a child node 381 (“DCR 1”). The child node 381 (“DCR 1”) in turn has a plurality of properties including a derived property “Average Temperature” 390, and a plurality of child nodes corresponding, respectively, to different physical temperature sensors. For example, a child node 391 (“1st Floor—Zone 2.1”) corresponds to a physical temperature sensor, and has a plurality of properties including a dynamic property “Temperature” 399, which may be updated based on data received from the physical temperature sensor.

As with resource consumption data, the inventors have recognized and appreciated that arranging sensor data in a hierarchical manner may advantageously allow a user to easily “zoom in” or “zoom out” to view relevant information at different levels. Also, relevant information (e.g., average temperature) may be aggregated by traversing the hierarchical structure, for example, from physical temperature sensor readings (e.g., the dynamic property “Temperature” 399 of the node 391), to sub-area averages (e.g., the derived property “Average Temperature” 390 of the node 381), to area averages (e.g., the derived property “Average Temperature” 380 of the node 371), and then to site average (e.g., the derived property “Average Temperature” 370 of the node 337). One or more of the intermediate values may be stored for later use.

Although consumption data is organized based on load category in the illustrative object tree 300, it should be appreciated that aspects of the present disclosure are not so limited. In some embodiments, consumption data may be organized based on equipment type (e.g., AC units, heating furnaces, pumps, water heaters, lighting fixtures, refrigerators, ovens, etc.) in addition to, or instead of, load category. Accordingly, a hierarchical structure similar to the illustrative object tree 300 may be constructed that includes nodes corresponding respectively to different equipment types (e.g., an “AC Units” child node, a “Water Heaters” child node, a “Pumps” child node, etc.) This may advantageously allow aggregation of consumption data by equipment type (e.g., total demand power from all AC units). However, it should be appreciated that aspects of the present disclosure are not limited to organizing consumption data based on equipment type.

Furthermore, although examples are provided relating to consumption of electricity, a consumption management system may manage one or more other types of resources in addition to, or instead of, electricity. For instance, the illustrative object tree may be augmented to include a “Billing Gas Meter” node corresponding to total natural gas consumption, a “Billing Water Meter” corresponding to total water consumption, etc., in addition to the “Billing Electric Meter” node 330. Pieces of equipment that consume natural gas, water, etc. may be organize in any suitable manner (e.g., by load category, equipment type, location, sub-meter, etc.).

The inventors have further recognized and appreciated that a hierarchical data structure such as the object tree 300 shown in FIGS. 3A-3F may be used to reduce instrumentation, which may reduce costs, and/or data volume and/or complexity. For instance, certain asset types (e.g., lighting) may include units that are too numerous to monitor individually. Such units may be represented collectively in the object tree 300, and only one sensor may be installed to monitor collective behavior of all of the units. For instance, with reference to FIG. 3C, the node 333 (“Total Plug and Lighting”) may be a leaf node, and may have one or more properties but no child node.

Although various advantages of a hierarchical data structure is discussed above, it should be appreciated that aspects of the present disclosure are not limited to the use of a hierarchical data structure. Also, details of implementation are shown in FIGS. 3A-3F and described above solely for purposes of illustration. Aspects of the present disclosure are not limited to any particular design of an object tree (e.g., a number of levels, what is represented logically by each level, what data is stored, etc.).

FIG. 4 shows an illustrative state transition diagram 400 for a consumption management event, in accordance with some embodiments. For instance, a consumption management event (or “event” for short) may be detected by the illustrative event detection module 130 in the example of FIG. 1, and a corresponding record may be stored in the illustrative event data store 140 in the example of FIG. 1. Such a record may include one or more proposed measures for reducing resource consumption, and/or expected savings that may result from implementing the one or more consumption reduction measures.

In some embodiments, an event may transition through multiple states. For instance, in the example shown in FIG. 4, a newly detected event may begin in a state 405 (“New”), where the event may await a user's review. Once the user reviews and approves the event for implementation, the event may transition into a state 410 (“To Be Implemented”).

Implementation of a proposed consumption reduction measure may involve one or more actions such as upgrading one or more pieces of equipment (e.g., replacing fluorescent light fixtures with LED light fixtures that are more energy efficient), adjusting one or more operating parameters (e.g., temperature set points on thermostats), adjusting one or more operating schedules (e.g., when to turn pumps on/off), etc. Such an action may be performed by one or more employees of an enterprise operating a site at which the event is detected. However, that is not required, as in some embodiments one or more resource consumption consultants working for a third party vendor (e.g., a vendor that provides resource consumption consulting services via the illustrative consumption management system 100 in the example of FIG. 1) may take part in the implementation in addition to, or instead of, the one or more site employees.

In the example shown in FIG. 4, an event in the state 410 (“To Be Implemented”) may transition to a state 415 (“Implemented”) once the one or more proposed measures associated with the event have been implemented. In some embodiments, a user who did not take part in the implementation may verify that the one or more proposed measures have been correctly implemented. While the user performs this verification, the event may reside in a state 420 (“To Be Validated”), and may transition to a state 425 (“Validated”) once the validation is completed successfully.

The inventors have recognized and appreciated a state transition diagram such as the illustrative state transition diagram 400 may be used to track progress of implementation of consumption reduction measures. For instance, statistics may be collected regarding how long events reside in various states. Such statistics may be used to identify and correct potential workflow issues (e.g., insufficient staffing). However, it should be appreciated that aspects of the present disclosure are not limited to the use of any particular state transition diagram to track consumption management events, or any state transition diagram at all.

The inventors have recognized and appreciated various challenges in quantifying resource savings that have resulted from implementation of one or more consumption reduction measures. For instance, savings may be computed based on a difference between consumption of a certain resource (e.g., electricity, natural gas, water, etc.) during a reporting period (e.g., current calendar year) and consumption of the same resource during a baseline period (e.g., some prior calendar year). However, such a comparison may not be fair, because conditions during the reporting period may not be identical to conditions during the baseline period. As an example, the reporting period temperature may be on average much warmer than the baseline period temperature, and as a result electricity consumption may be higher (e.g., to operate AC units) and natural gas consumption may be lower (e.g., to operate furnaces). As another example, production may have increased between the baseline period and the reporting period (e.g., longer operating hours and/or more operating equipment), and as a result more energy may be consumed, even though energy consumption per unit output may stay the same. As yet another example, a one-time event (e.g., closure due to renovation, natural disaster, etc.) may have occurred during the baseline period, with no comparable event during the reporting period, or vice versa. Accordingly, one or more adjustments may be made to facilitate a fair comparison between reporting period consumption and baseline period consumption.

In some embodiments, resource savings calculations may be performed following one or more guidelines provided in the International Performance Measurement and Verification Protocol (IPMVP), which is developed by the Efficiency Valuation Organization (EVO). While the IPMVP outlines recommended practices for measuring and verifying resource savings, the inventors have recognized and appreciated various technical challenges in implementing some of these recommended practices in a consumption management system. For instance, conventional implementations tend to be developed in an ad hoc manner (e.g., for a specific project, facility, enterprise, vertical, etc.), and may not be easily extended to handle different types of input data or calculations. Accordingly, in some embodiments, one or more of the techniques described herein for processing and storing data from disparate sources may be used to facilitate measurement and verification of resource savings.

In some embodiments, a consumption management system (e.g., the illustrative consumption management system 100 in the example of FIG. 1) may include a baseline module programmed to establish a resource consumption baseline, which may be used to calculate savings resulting from implementation of one or more consumption reduction measures.

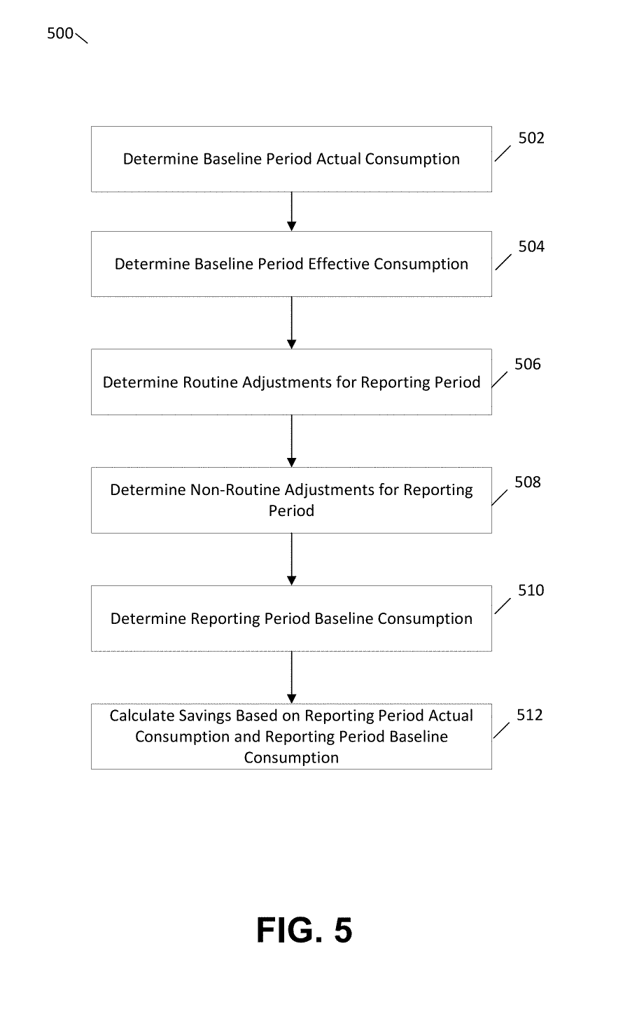

FIG. 5 shows an illustrative process 500 for calculating savings in resource consumption, in accordance with some embodiments. For instance, the process 500 may be performed by a baseline module of a consumption management system (e.g., the illustrative consumption management system 100 in the example of FIG. 1) to establish a resource consumption baseline, and to use the resource consumption baseline to calculate savings resulting from implementation of one or more consumption reduction measures. However, it should be appreciated that aspects of the present disclosure are not limited to the use of a baseline module, as any of the baseline-related functionalities described herein may be performed by any suitable component of the consumption management system. Moreover, aspects of the present disclosure are not limited to the use of any particular baseline-related functionality.

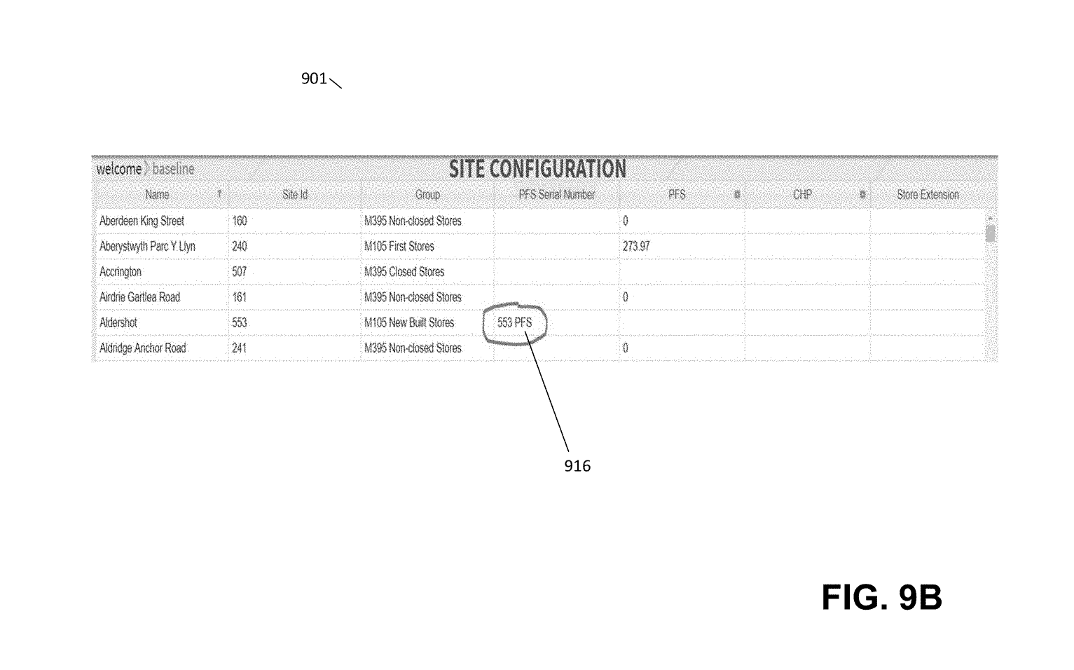

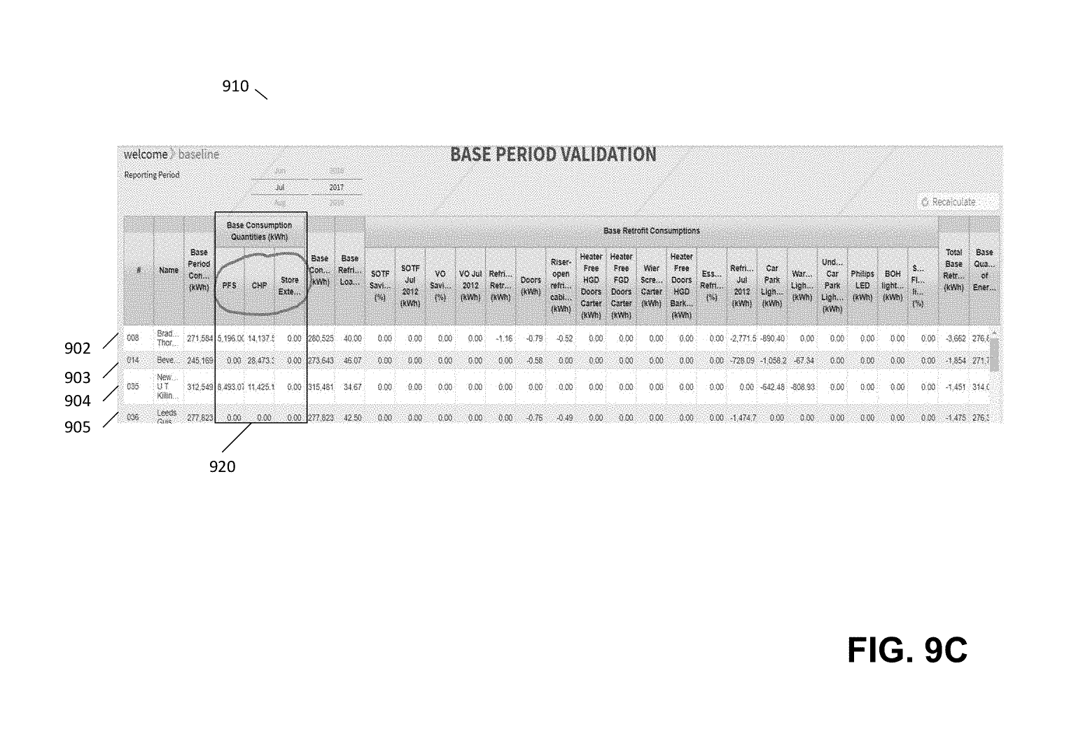

The resource consumption baseline may have any suitable scope. As used herein, a “scope” for a baseline refers to a delineation of aspects of an enterprise's operations, such that a baseline has relevance to those aspects, and not to other aspects of the operations. For instance, the resource consumption baseline may be established for an entire enterprise, the enterprise's operations within one or more geographical regions, one or more sites operated by the enterprise, one or more buildings within a site, etc. Additionally, or alternatively, one or more techniques may be used to indicate one or more particular elements as being within or outside the scope of the resource consumption baseline. Examples of such techniques are described in connection with FIGS. 9A-9C.

In the example of FIG. 5, actual consumption during a baseline period may be determined at act 502. A baseline period may be chosen in any suitable manner. For instance, a baseline period may be a chosen time period that is before implementation of one or more consumption reduction measures, whereas a reporting period may be a time period after implementation of the one or more consumption reduction measures, so that a difference between baseline period consumption and reporting period consumption may be indicative of an impact of the one or more consumption reduction measures. In some embodiments, to provide a meaningful comparison, the baseline period may be chosen to be similar to the reporting period in one or more aspects, such as having a similar duration (e.g., two years, one year, six months, three months, one month, two weeks, one week, one work week, one day, etc.) and/or commencing at a similar time (e.g., beginning of calendar or fiscal year, peak consumption season, etc.).

Additionally, or alternatively, the baseline period and the reporting period may be separated by a period of time during which the one or more consumption reduction measures are implemented. The inventors have recognized and appreciated that resource consumption during such an intervening period of time may be erratic (e.g., equipment may be taken offline to implement the one or more consumption reduction measures), and therefore resource savings may be quantified more accurately by using a baseline period that excludes the intervening period.

In some embodiments, actual consumption during a baseline period may be determined from historical data such as consumption data (e.g., in kWh) and demand data (e.g., in kW) from one or more utility meters, where consumption may be determined as demand over time, and/or invoice data (e.g., amount of resource consumed, amount of money paid for consumption, tariff profiles, etc.). In some embodiments, historical data may be obtained from records kept by an enterprise for which the resource consumption baseline is being established. Additionally, or alternatively, historical data may be retrieved from one or more data stores of a consumption management system (e.g., the illustrative consumption management system 100 in the example of FIG. 1) via one or more suitable interfaces (e.g., the illustrative query interface 180 in the example of FIG. 1). Such historical data may have been stored by the consumption management system based on data received from one or more data sources (e.g., the illustrative data sources 115, 116, . . . in the example of FIG. 1). However, it should be appreciated that aspects of the present disclosure are not limited to the use of historical data of any particular type, or from any particular source.

In some embodiments, historical data relating to actual consumption during a baseline period may be analyzed to identify one or more elements that are outside the scope of a resource consumption baseline that is being established. Additionally, or alternatively, historical data may be collected for one or more elements within the scope of a resource consumption baseline that is being established, but are not yet taken into account. For instance, a site may have a main meter, but one or more loads at the site may be separately metered. Thus, consumption data for the one or more loads may be collected, in addition to data from the main meter.

In some embodiments, historical data relating to actual consumption during a baseline period may be analyzed to identify invalid data values and/or missing data values. This may be done in any suitable manner, for example, by applying one or more validity rules as discussed in connection with the illustrative data import module 120 in the example of FIG. 1 Likewise, any one or more suitable techniques may be used to correct invalid data values and/or missing data values. For instance, a nominal value, an interpolated value, or an historically-appropriate value may be used when an invalid or missing data value is identified, as discussed in connection with the illustrative data import module 120 in the example of FIG. 1.

Referring again to FIG. 5, a baseline period effective consumption may be determined at act 504. In some embodiments, the baseline period effective consumption may be determined by identifying one or more incidents that occurred during the baseline period and may have affected resource consumption, estimating an impact of the one or more incidents, and making one or more adjustments to the actual baseline period consumption determined at act 502 to reflect the estimated impact of the one or more incidents. As an example, a retrofit project may have taken place at a site during the baseline period, and may have resulted in reduced resource consumption going forward. An amount of reduction that is attributable to the retrofit project may be determined by comparing consumption data before the retrofit project and consumption data after the retrofit project. The baseline period effective consumption may be determined by adjusting the baseline period actual consumption to account for such reduction (e.g., amount of resource saved per day, week, month, etc.). For example, an adjustment value corresponding to the amount of reduction may be subtracted from the baseline period actual consumption. In some embodiments, the reduction may be applied to a portion of the baseline period before the retrofit project was completed, so that the baseline period effective consumption may reflect an amount of resource that would have been consumed had the retrofit project been completed prior to the baseline period.

As another example, an expansion project may have taken place at a site during the baseline period, and may have resulted in increased resource consumption going forward. An amount of increase that is attributable to the expansion project may be determined by comparing consumption data before the expansion project and consumption data after the expansion project. The baseline period effective consumption may be determined by adjusting the baseline period actual consumption to account for such increase (e.g., amount of additional resource consumed per day, week, month, etc.). For example, an adjustment value corresponding to the amount of increase may be added to the baseline period actual consumption. In some embodiments, the increase may be applied to a portion of the baseline period before the expansion project was completed, so that the baseline period effective consumption may reflect an amount of resource that would have been consumed had the expansion project been completed prior to the baseline period.

In some embodiments, adjustment of the baseline period actual consumption to account for the incident facilitates a fair comparison between reporting period consumption and baseline period effective consumption because the reporting period consumption is also impacted by the incident. In some embodiments, the baseline period effective consumption may include determination of the effective consumption (e.g., in kWh) and/or determination of effective consumption cost (e.g., in USD, GBP, etc.).

At act 506 in the example of FIG. 5, one or more routine adjustments may be determined. In some embodiments, routine adjustments are adjustments corresponding to variables that continuously and regularly impact the resource consumption during the reporting period. In some embodiments, a routine adjustment may be determined for one or more variables that impact resource consumption regularly during the reporting period. For instance, one or more routine adjustments may be made based on weather (e.g., external ambient temperature), operating hours (e.g., number of hours in which a store is open), production volume (e.g., number of production lines that are running in a factory, number of units produced, etc.), occupancy (e.g., number of guests staying at a hotel), etc.

In some embodiments, a routine adjustment may be determined for a variable of interest by estimating a relationship between that variable and resource consumption. Any suitable technique may be used to estimate such a relationship. For instance, a statistical analysis, such as a regression analysis, may be performed, where the variable of interest may be treated as an independent variable, and resource consumption may be treated as a dependent variable. Such an analysis may be based on the baseline period effective consumption determined at act 504.

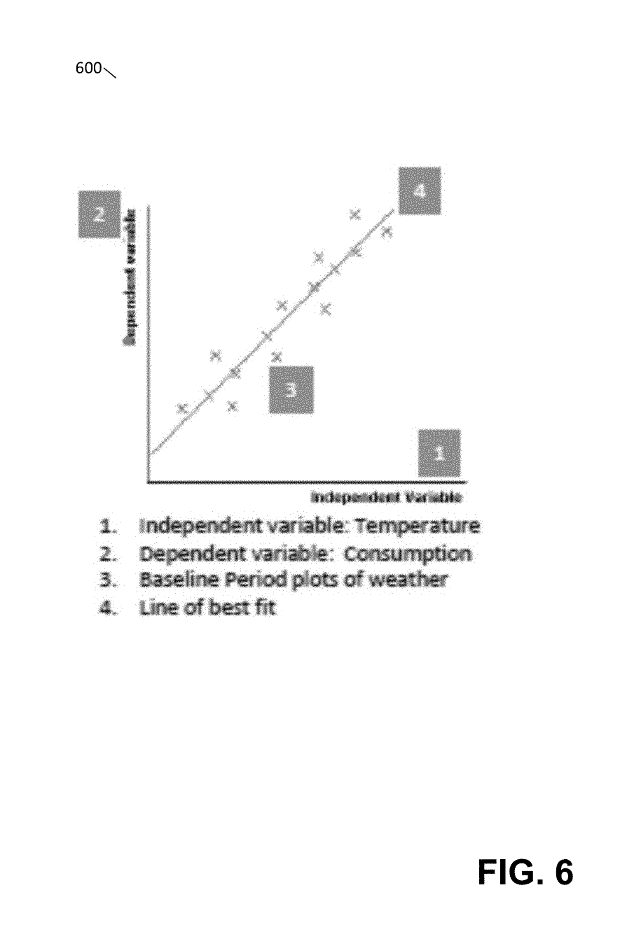

FIG. 6 shows an illustrative plot 600 of resource consumption against a variable of interest, in accordance with some embodiments. In this example, the variable of interest is temperature, which is treated as an independent variable (x-axis, labeled “1” in FIG. 6), while resource consumption is treated as a dependent variable (y-axis, labeled “2” in FIG. 6). Resource consumption data from the baseline period is plotted against temperature (labeled “3” in FIG. 6), and a line of best fit may be calculated (labeled “4” in FIG. 6). Any suitable technique may be used to calculate a best fit, such as a least squares technique, and the analysis may be performed at any suitable resolution (e.g., using resource consumption and temperature data collected hourly, daily, weekly, monthly, etc.). Furthermore, it should be appreciated that aspects of the present disclosure are not limited to the use of a linear fit, as any other suitable curve may also be used, such as a logarithmic curve, an exponential curve, a polynomial curve of degree N=2, 3, . . . , etc.

In some embodiments, an estimated relationship between a variable of interest and resource consumption may be used to adjust the baseline period effective consumption determined at act 504 in the example of FIG. 5 to match conditions of a reporting period. For instance, with reference to the example of FIG. 6, the estimated relationship between temperature and resource consumption may be used to adjust resource consumption up (or down) based on an increase (or a drop) in temperature from the baseline period to the reporting period. In this manner, a result of the routine adjustment may reflect an amount of resource that would have been consumed during the baseline period as if the weather in the baseline period had been identical to the weather in the reporting period.

It should be appreciated that aspects of the present disclosure are not limited to making routine adjustments based on temperature differences, as the illustrative technique described above in connection with FIG. 6, and/or any other suitable technique, may be used to make routine adjustments based on differences in any one or more variables of interest (e.g., operating hours, production volume, occupancy, etc.) in addition to, or instead of, temperature. Referring again to FIG. 5, one or more non-routine adjustments may be determined at act 508. In some embodiments, a non-routine adjustment may be determined for an incident that occurs during the reporting period and may affect resource consumption going forward. An impact of such an incident may be used to adjust the baseline period effective consumption determined at act 504 in the example of FIG. 5 to match conditions of the reporting period.

As an example of an incident, new equipment may be installed at a site during the reporting period, and may result in reduced resource consumption going forward. The new equipment may be unrelated to the one or more consumption reduction measures for which the resource consumption baseline is being established, and therefore an amount of reduction that is attributable to the new equipment may be incorporated into the baseline. In some embodiments, the amount of reduction attributable to the new equipment may be determined by comparing consumption data before the new equipment is installed and consumption data after the new equipment is installed. An adjustment value corresponding to the amount of reduction (e.g., amount of resource saved per day, week, month, etc.) may be applied to a portion of the baseline period after a time corresponding to installation of the new equipment in the reporting period. For instance, if new equipment is installed on July 1 in a reporting year, a reduction attributable to the new equipment may be applied after July 1 in a baseline year. In this manner, a result of the non-routine adjustment may reflect an amount of resource that would have been consumed during the baseline period as if the new equipment had been installed in the baseline period at a time corresponding to the actual installation time in the reporting period.

As another example of an incident, an expansion project may take place at a site during the reporting period, and may result in increased resource consumption going forward. The expansion project may be unrelated to the one or more consumption reduction measures for which the resource consumption baseline is being established, and therefore an amount of increase that is attributable to the expansion project may be incorporated into the baseline. The amount of increase attributable to the expansion project may be determined by comparing consumption data before the expansion project and consumption data after the expansion project. An adjustment value corresponding to the amount of increase (e.g., amount of additional resource consumed per day, week, month, etc.) may be applied to a portion of the baseline period after a time corresponding to completion of the expansion project in the reporting period. For instance, if the expansion project is completed on July 1 in a reporting year, an increase attributable to the expansion project may be applied after July 1 in a baseline year. In this manner, a result of the non-routine adjustment may reflect an amount of resource that would have been consumed during the baseline period as if the expansion project had been completed in the baseline period at a time corresponding to the actual completion time in the reporting period. It will be appreciated that in some instances an energy project undertaken by an enterprise operating a site independent from a consumption management service may also result in increased resource consumption. For example, installation of new equipment in some cases can lead to increase in resource consumption.

In some embodiments, a non-routine adjustment may be determined for an incident that occurs during the reporting period and may affect resource consumption for one or more particular time periods. As an example of such an incident, a one-time event, such as, a site closure for a month due to natural disaster, may take place at the site during the reporting period, and may result in reduced resource consumption for the particular time period (for example, a month). The incident may be unrelated to the one or more consumption reduction measures for which the resource consumption baseline is being established, and therefore an amount of reduction that is attributable to the incident may be incorporated into the baseline. The amount of reduction attributable to the incident may be determined by comparing consumption data before the event and consumption data after the event. An adjustment value corresponding to the amount of reduction may be applied to a portion of the baseline period after a time corresponding to occurrence of the event in the reporting period. For instance, if the incident occurred on July 1 in a reporting year, a reduction attributable to the incident may be applied to the particular time period after July 1 in a baseline year. For example, if the incident resulted in site closure for a month in the reporting period, the reduction attributable to the incident may be applied from July 1 to August 1 in the baseline year.

At act 510, reporting period baseline consumption may be determined by applying one or more routine adjustments determined at act 506 and/or one or more non-routine adjustments determined at act 508 to the baseline period effective consumption determined at act 504, as discussed above. In some embodiments, the reporting period baseline consumption may include determination of the baseline consumption (e.g., in kWh) and/or determination of baseline consumption cost (e.g., in USD, GBP, etc.).

At act 512, savings resulting from implementation of the one or more consumption reduction measures in question may be calculated as a difference between reporting period actual consumption and the reporting period baseline consumption established at act 510. Reporting period actual consumption may be determined based on any one or more suitable types of data (e.g., consumption data from one or more utility meters, demand data, invoice data, etc.) from any one or more suitable sources (e.g., enterprise records, data stores of consumption management system, etc.), which may be the same as, or different from, the types of data and the sources used at act 502 to determine the baseline period actual consumption.

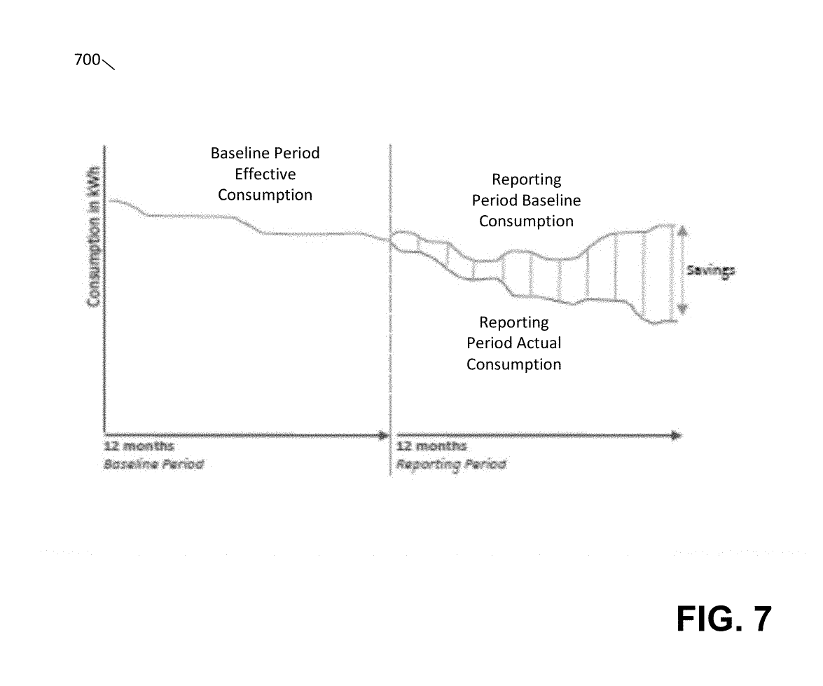

FIG. 7 shows an illustrative plot 700 of resource consumption against time, in accordance with some embodiments. In this example, two time periods are shown, namely, a 12-month baseline period and a 12-month reporting period. A baseline period effective consumption (e.g., as determined at act 504 in the example of FIG. 5) is plotted over the baseline period, and a reporting period baseline consumption (e.g., as determined at act 510 in the example of FIG. 5) is plotted over the reporting period. A reporting period actual consumption is also plotted over the reporting period, and a difference between the reporting period baseline consumption and the reporting period actual consumption represents savings attributable to one or more consumption reduction measures for which the reporting period baseline consumption has been established (e.g., as determined at act 512 in the example of FIG. 5).

The inventors have recognized and appreciated that, when multiple consumption reduction measures are implemented at roughly the same time, it may be challenging to isolate savings attributable to each individual consumption reduction measure. Accordingly, in some embodiments, one or more of the techniques described in connection with FIGS. 5-7 may be used to calculate collective savings resulting from multiple consumption reduction measures. However, it should be appreciated that aspects of the present disclosure are not so limited. In some embodiments, one or more of the techniques described herein may be used to calculate savings resulting from a single consumption reduction measure.

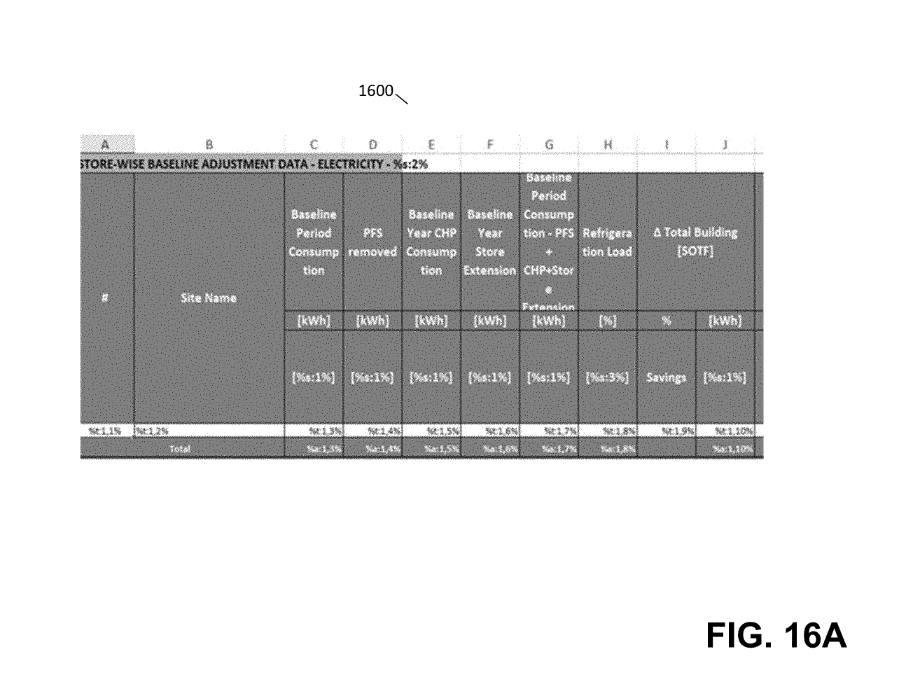

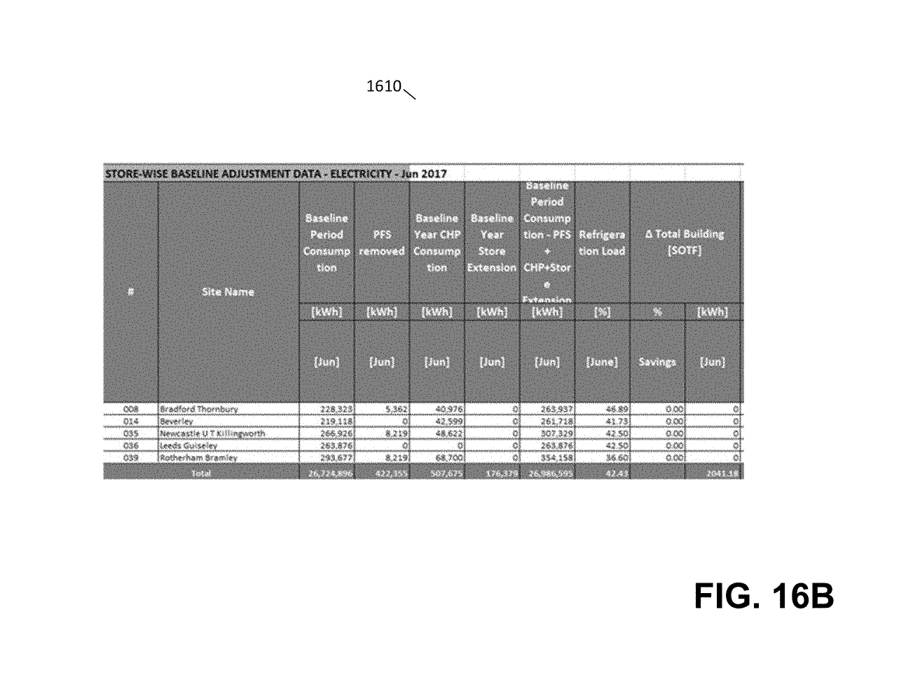

In some embodiments, calculated savings may be reported on a regular basis, for example, monthly, quarterly, semi-annually, annually, etc. Additionally, or alternatively, calculated savings may be reported upon user request, for example, via a user interface (e.g., a web portal or a mobile device app) of a consumption management system. The calculated savings may be reported in terms of reduction in resource consumption (e.g., in kWh) and/or reduction in costs (e.g., in USD, GBP, etc.). In some embodiments, the baseline module generates customizable reports (for reporting baseline and/or reporting period resource consumption, calculated savings, etc.) based on pre-defined templates. An exemplary template is depicted in FIG. 16A and an exemplary report generated based on the template is depicted in FIG. 16B. In some embodiments, the report provides information that allows the calculated savings to be validated.

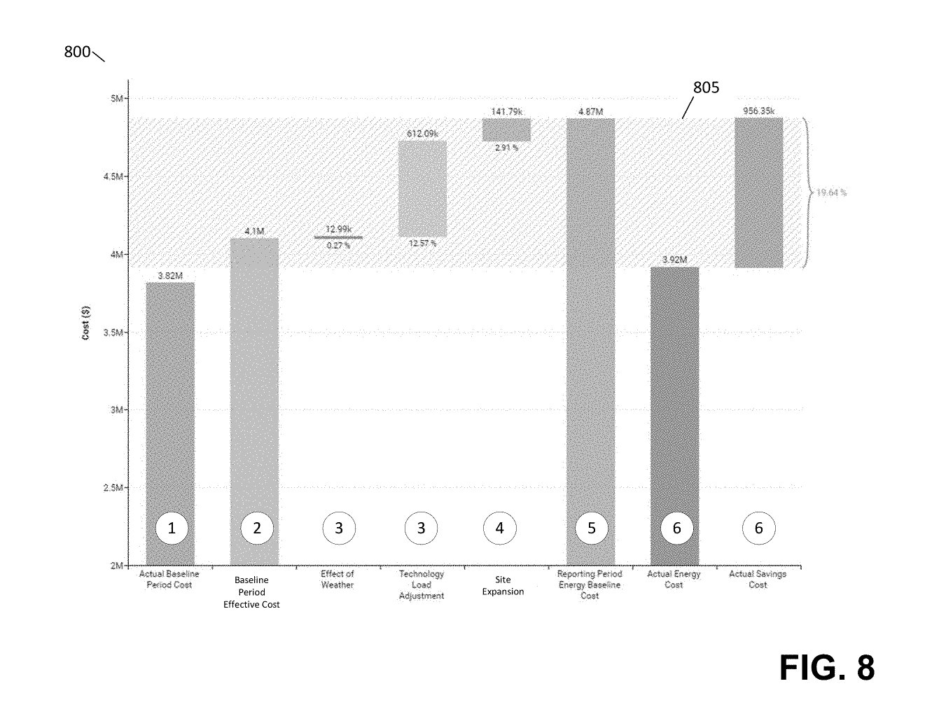

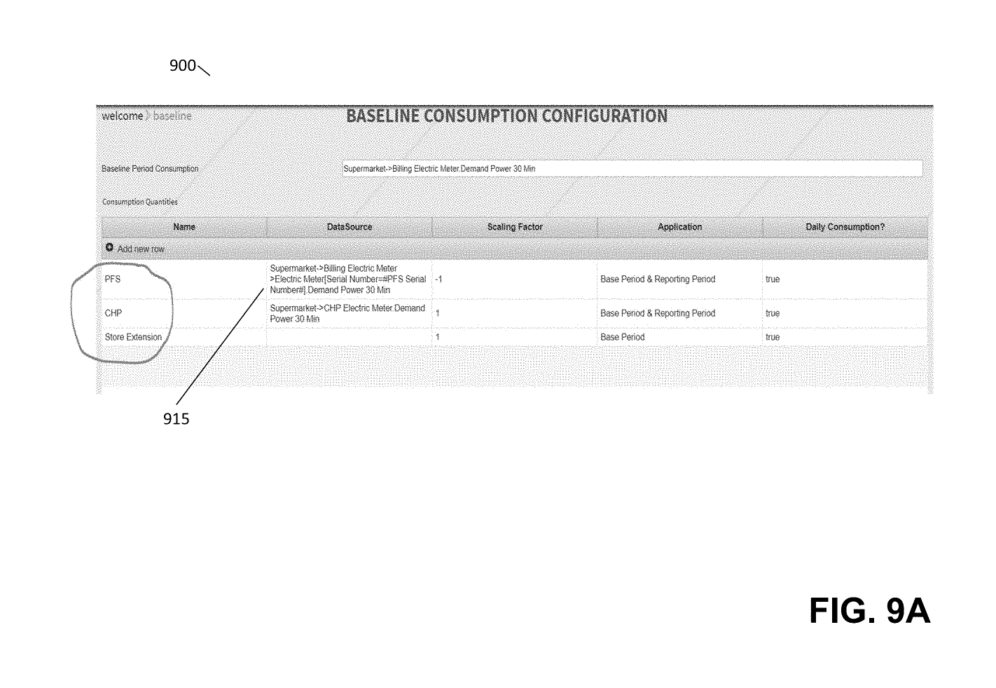

FIG. 8 shows an illustrative waterfall chart 800 that visually explains how savings are calculated, in accordance with some embodiments. The inventors have recognized and appreciated that it may be beneficial to provide a visual explanation of savings that may allow a user to understand how one or more consumption reduction measures are performing, without necessarily the user needing to expend excessive time or cognitive effort. Accordingly, in some embodiments, techniques are provided for visually illustrating savings calculations in a manner that is comprehensive and yet concise and intuitive.

In the example shown in FIG. 8, baseline period actual cost (e.g., as determined at act 502 in the example of FIG. 5) is shown in a column labeled “1” in FIG. 8, and baseline period effective cost (e.g., as determined at act 504 in the example of FIG. 5) is shown in a column labeled “2” in FIG. 8, adjacent to the baseline period actual cost column. In this manner, a user may be able to see, at a glance, how the baseline period effective cost compares against the baseline period actual cost.

Referring again to the example shown in FIG. 8, two columns, both labeled “3” in FIG. 8, are shown adjacent to the baseline period actual cost column (“2”). In this example, these columns represent, respectively, effect of weather and technology load changes from a baseline period to a reporting period (e.g., as determined at act 506 in the example of FIG. 5). A column labeled “4” in the example of FIG. 8 is shown adjacent to the weather and technology load columns (“3”), and may represent effects of a site expansion project completed during the reporting period (e.g., as determined at act 508 in the example of FIG. 5). In the example of FIG. 8, a column labeled “5” in FIG. 8 is shown adjacent to the site expansion column (“4”), and may represent reporting period baseline cost (e.g. as determined at act 510 in the example of FIG. 5), which is a sum of the columns labeled “2” through “4.” In this manner, a user may be able to see, at a glance, how the reporting period baseline cost represented by the column labeled “5” is broken down into various components represented, respectively, by the columns labeled “2” through “4.”

Referring again to the example shown in FIG. 8, two columns, both labeled “6” in FIG. 8, are shown adjacent to the reporting period baseline cost column (“5”). These columns represent, respectively, reporting period actual cost and reporting period savings (e.g., as determined at act 512 in the example of FIG. 5). The reporting period savings column (“6,” right), is a difference between the reporting period baseline cost column (“5”) and the reporting period actual cost column (“6,” left). In this manner, a user may be able to see, at a glance, how much has been saved as a resulting of implementing the one or more consumption reduction measures, relative to how much resource would have been consumed had the one or more consumption reduction measures not been implemented.

In some embodiments, a horizontal band is provided, and may intersect one or more columns in the illustrative waterfall chart 800 in the example of FIG. 8. A height of the horizontal band coincides with the reporting period savings column (“6,” right). Additionally, or alternatively, a vertical location of the horizontal band coincides with the reporting period savings column (“6,” right). In this manner, a user may be able to see, at a glance, that because of the one or more consumption reduction measures, the reporting period actual cost (“6,” left) is lower than the baseline period actual cost (“1”), despite many factors that would have led to higher consumption, such as site expansion in the reporting period (“4”), effect of weather and production load changes in the reporting period (“3”), and higher baseline period effective cost (“2”).

Although the inventors have recognized and appreciated various advantages of a visual explanation such as the illustrative waterfall chart 800 in the example of FIG. 8, it should be appreciated that aspects of the present disclosure are not limited to the use of waterfall chart, as other visual representations may also be suitable. Furthermore, aspects of the present disclosure are not limited to the particular columns shown in FIG. 8, or the particular order in which the columns are arranged in FIG. 8.

The inventors have recognized and appreciated that accurate determination of the resource consumption baseline relies on identification of one or more particular elements as being within or outside the scope of the resource consumption baseline. Accordingly, in some embodiments, one or more techniques (performed by the baseline module, for example) described in connection with FIGS. 9A-9C may be used to identify the elements that are within or outside the scope of the resource consumption baseline and dynamically integrate the identified elements into resource consumption calculations (e.g., baseline period effective consumption determination, reporting period baseline consumption determination, or both). The inventors have recognized and appreciated that different clients/enterprises may have different elements that are within or outside the scope of the respective resource consumption baselines, and have, therefore, provided scalable techniques that can be applied when creating or updating different client applications.

FIG. 9A shows an illustrative graphical user interface (GUI) 900 that defines and identifies one or more elements as being within or outside the scope of the resource consumption baseline for one or more sites. GUI 900 includes a table with a number of columns titled “Name”, “DataSource”, “Scaling Factor”, and “Application.” The “Name” column lists the one or more elements, for example, petrol filling station (PFS), combined heat and power meter (CHP), and Store Extension. The “DataSource” column defines, for each element, parameterized queries that, at run time, gather consumption/load data from data sources associated with the respective element. For example, a parameterized query 915 for PFS includes a placeholder for the “PFS serial number”. An actual PFS serial number 916 can be supplied to the query at run time. While FIG. 9B shows the actual PFS serial number 916 being defined for a particular site, it will be appreciated that serial numbers can be defined for other sites as well.

Referring back to FIG. 9A, the “Scaling Factor” column indicates whether an element in the list is within scope or outside the scope of the resource consumption baseline. For example, the PFS element is defined as an element that is outside the scope of the resource consumption baseline by setting a scaling factor as “−1”. When defined as an element that is outside the scope, the consumption of the PFS element is not included in the baseline period consumption and/or the reporting period consumption. Also shown in FIG. 9A, a CHP element and a store extension element are defined as elements that are within the scope of the resource consumption baseline by setting a scaling factor for these elements as “1”. When defined as elements that are within the scope, the consumption of these elements is included in the baseline period consumption and/or the reporting period consumption. It will be appreciated that the depicted scaling factors are exemplary and other scaling factors can be used to define elements that are within and outside the scope.

As shown in FIG. 9A, the “Application” column indicates whether the element is defined as within or outside the scope for the baseline period, the reporting period, or both. For example, the PFS element is defined as an element that is outside the scope of the resource consumption baseline for both the baseline period and the reporting period. The CHP element is defined as an element that is within the scope of the resource consumption baseline for both the baseline period and the reporting period, while the “Store Extension” is defined as an element that within the scope of the resource consumption baseline for only the baseline period.

FIG. 9C shows an illustrative GUI 910 that visually depicts how the elements that are defined as within and outside the scope of the resource consumption baseline are dynamically integrated into the baseline period consumption and/or the reporting period consumption. In particular, a grid portion 920 of GUI 910 is dynamically generated and updated based on the addition or removal of elements in the table of FIG. 9A. For example, if an element is added to the list of elements in FIG. 9A, the grid portion 920 of FIG. 9C is expanded to include an additional sub-column for the added element. Similarly, if an element is removed from the list of elements in FIG. 9A, the grid portion 920 is compressed by removing the sub-column associated with removed element.

In some embodiments, the GUI 910 presents, in grid portion 920, baseline period consumption quantities associated with each of the elements defined in FIG. 9A. As shown in FIG. 9C. the grid portion 920 includes a “Base Consumption Quantities” column with three sub-columns that are added for each of the elements defined in FIG. 9A. The column to the “left” of the grid portion 920 includes baseline period consumption values for different sites before the consumption quantities of the elements of FIG. 9A are taken into account. The column to the “right” of the grid portion 920 includes baseline period consumption values that have been adjusted to account for the elements of FIG. 9A. For example, for each entry 902, 903, 904, 905 in the table, the baseline period consumption in the column to the “right” of the grid portion 920 is determined by adding the consumption quantities associated with elements that are defined as within the scope of the resource consumption baseline and subtracting the consumption quantities associated with elements that are defined as outside the scope of the resource consumption baseline. In some implementations, the “Base Consumption Quantities” column of grid portion 920 corresponds to a particular property (e.g., consumption quantities for the elements defined in FIG. 9A). In some embodiments, JSON (JavaScript Object Notation) objects can be used to implement the property such that the result of the property is a dictionary (i.e., a list of key values associated with the elements defined in FIG. 9A). Therefore, while one column “Base Consumption Quantities” is added to the grid portion 920, a number of sub-columns corresponding to the list of key values are dynamically added to the grid portion 920 (i.e., the key values—PFS, CHP, and Store Extension—are added as sub-column headers in the grid portion 920). In this manner, sub-columns can be dynamically added or removed from the grid portion 920 based on addition or deletion of elements from the list in FIG. 9A.

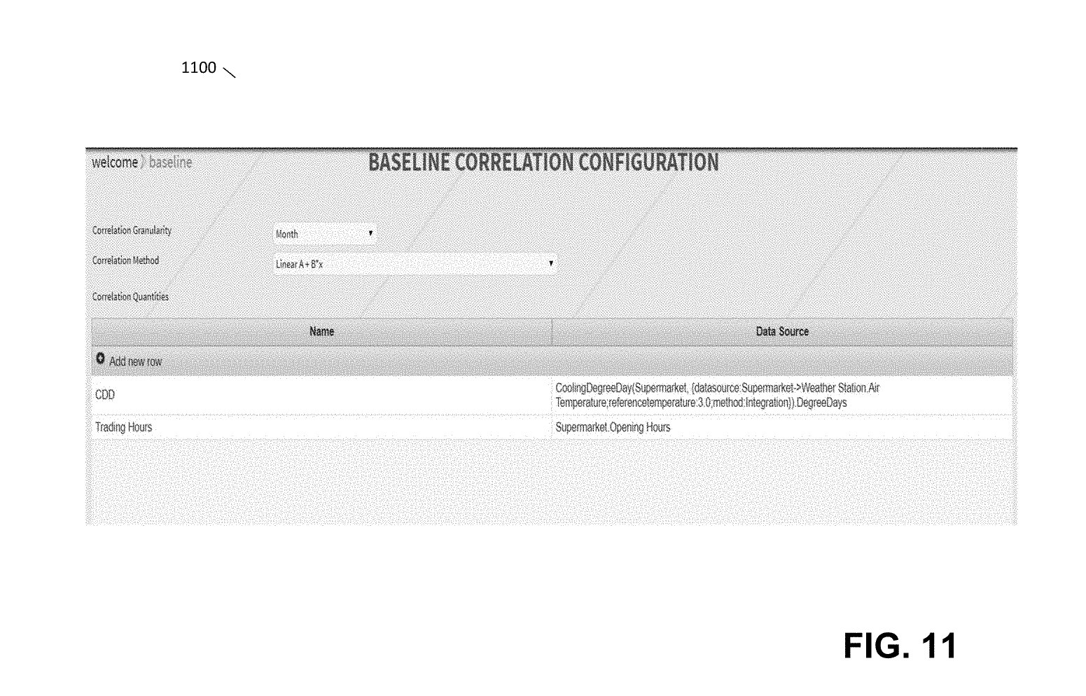

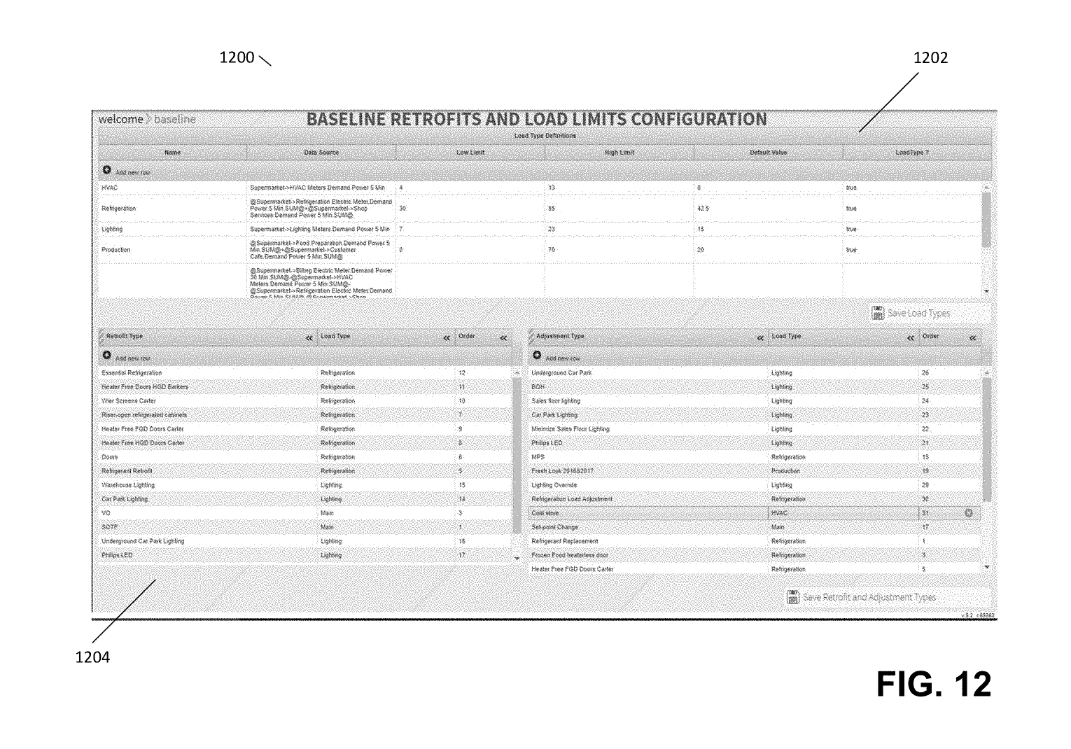

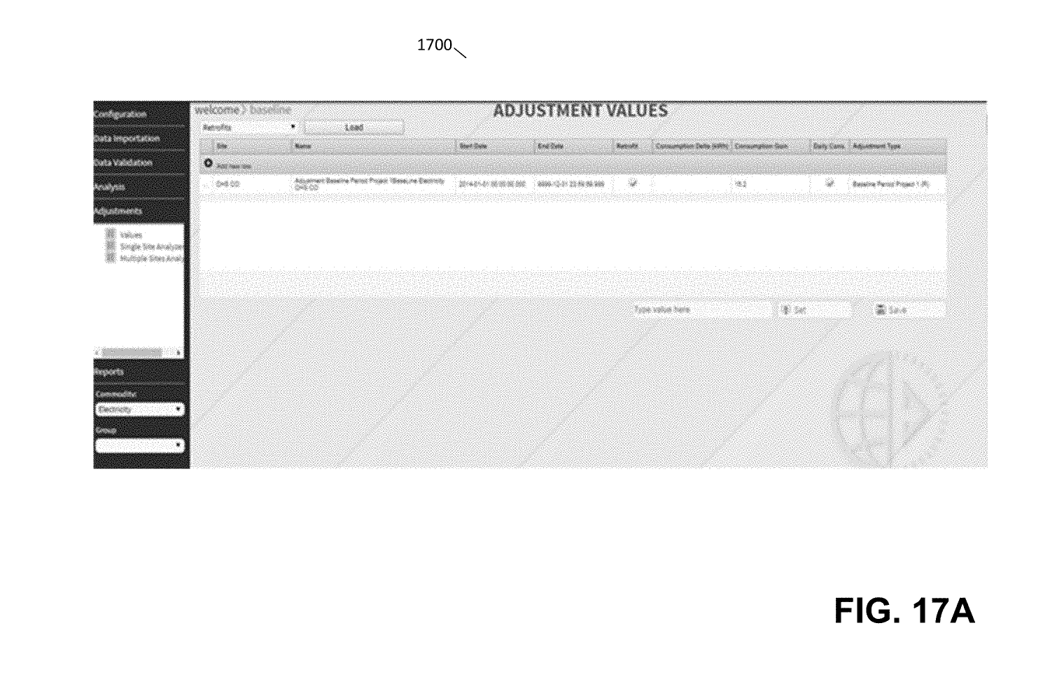

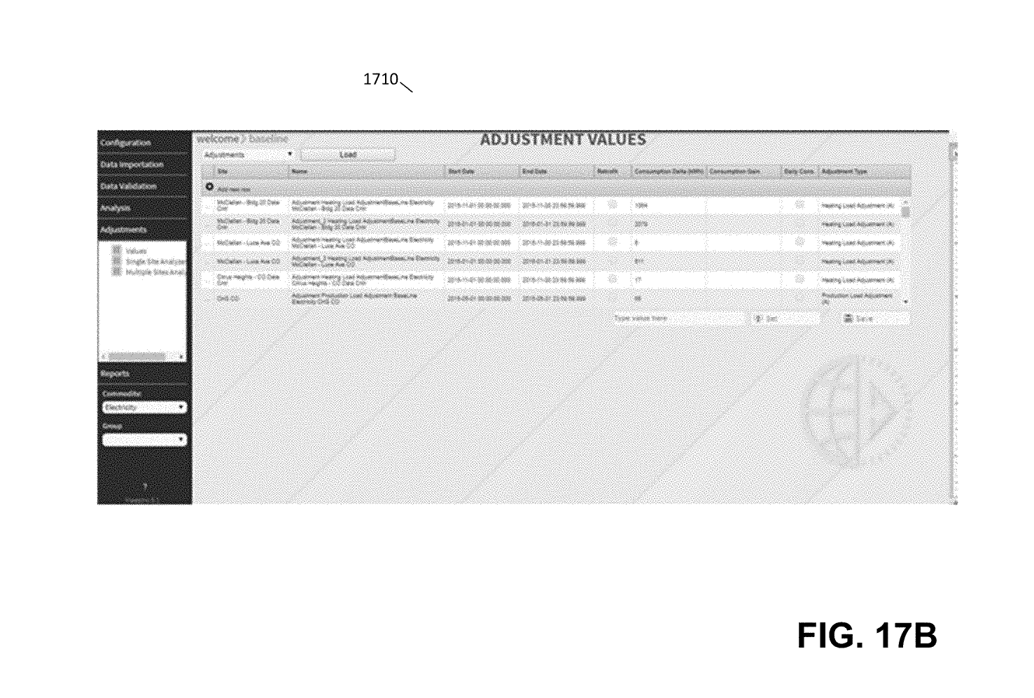

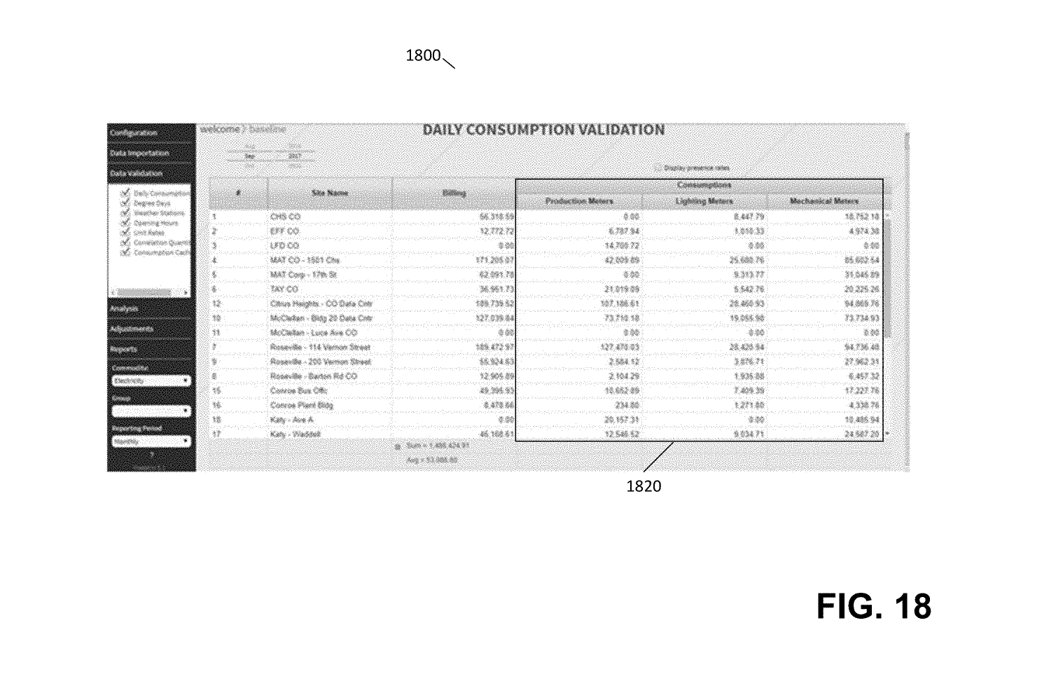

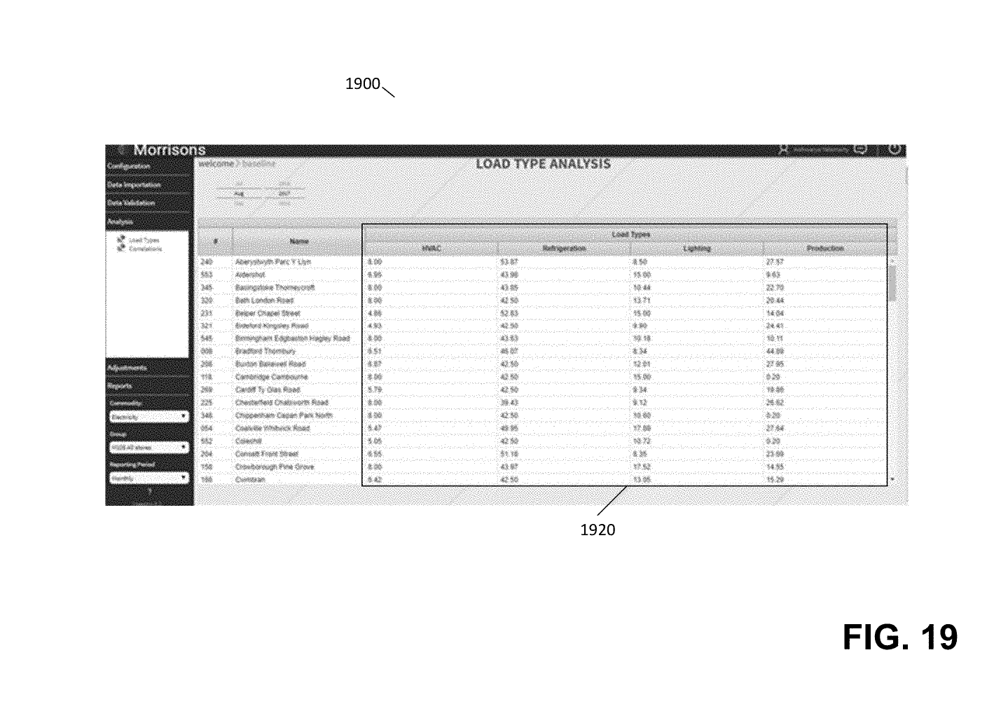

It will be appreciated that while the foregoing technique (as described in FIGS. 9A-9C) has been described with respect to identification and integration of elements that are within and outside the scope of the resource consumption baseline, this technique can be applied to other aspects as well. For example, routine adjustments (as shown in FIG. 11), baseline period non-routine adjustments (e.g., retrofits shown in FIG. 12 and FIG. 17A), and reporting period non-routine adjustments (e.g., adjustment types shown in FIG. 12 and FIG. 17B) can be defined and dynamically integrated into resource consumption calculations (e.g., baseline period effective consumption determination, reporting period baseline consumption determination, or both) using the foregoing technique. FIG. 18 shows an illustrative GUI 1800 that depicts a grid portion 1820 representing consumption for various meters, where the grid portion 1820 can be dynamically updated (by adding or removing sub-columns) based on addition or removal of meters. Similarly, FIG. 19 shows an exemplary GUI 1900 that depicts grid portion 1920 representing load associated with various load types, where the grid portion 1920 can be dynamically updated (by adding or removing sub-columns) based on addition or removal load types.

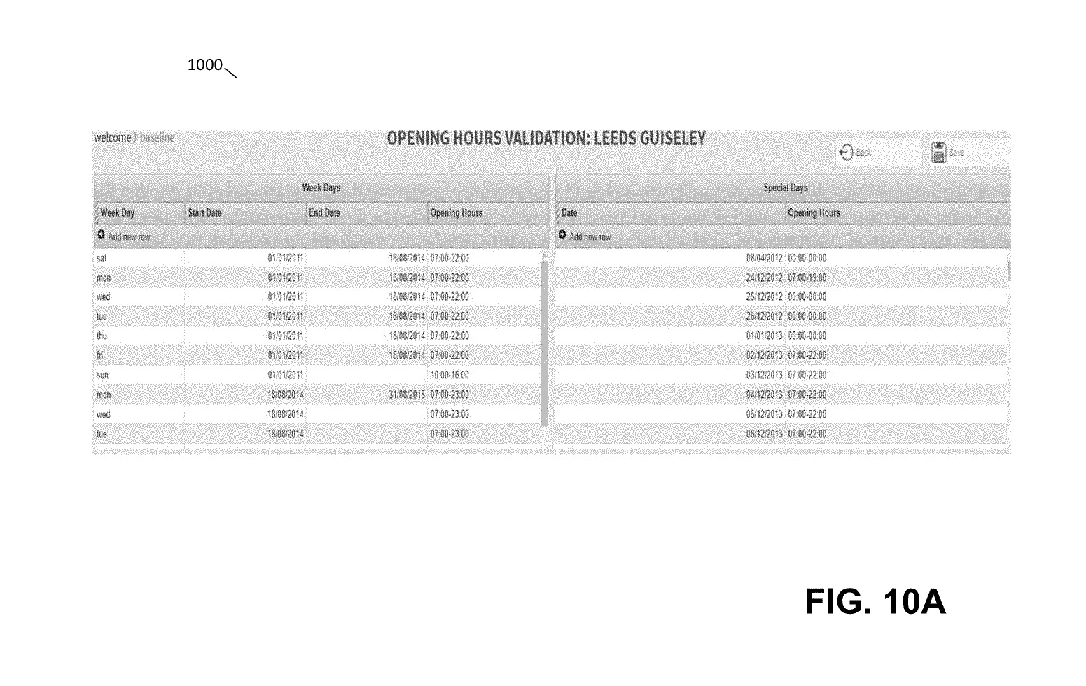

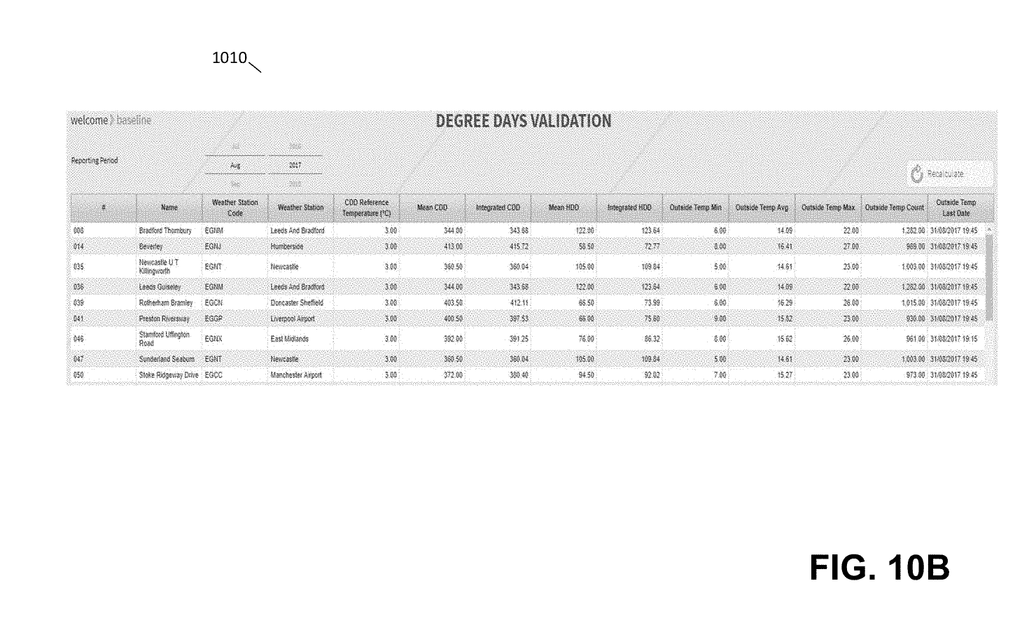

The inventors have recognized and appreciated that importation of data relating to variables that regularly impact resource consumption (e.g., opening hours, temperature, etc.) has been a largely manually process, which can be prone to error. Accordingly, in some embodiments, one or more techniques (performed by the baseline module or the data import module 120, for example) described in connection with FIGS. 10A-10B may be used to automatically import data and allow for visual verification and correction of the imported data, which results in higher accuracy in calculated savings.

In some implementations, the baseline module is configured to import or otherwise obtain “opening hours” data from various websites. For example, web-scraping tools may be used to extract the “opening hours” data from the websites. The obtained data may be presented in an exemplary GUI 1000 of FIG. 10A that allows a user to view and edit, and if desired, correct the “opening hours” data.

In some implementations, the baseline module is configured to import or otherwise obtain weather and/or other temperature data from weather stations (e.g., automated airport weather stations). The obtained weather data may be presented in an exemplary GUI 1010 of FIG. 10B. In addition, certain values, such as mean cooling degree days (CDD), integrated CDD, mean heating degree days (HDD), and integrated HDD may be calculated (by the baseline module) based on the CDD reference temperature.

As shown in FIG. 10B, the imported weather data can be easily viewed and validated such that any incorrect values can be edited and corrected. Correction of imported data may cause the mean CDD, integrated CDD, mean HDD, and integrated HDD values to be automatically re-calculated and updated. In some implementations, the validated weather data, in particular, the Mean CDD, Integrated CDD, Mean HDD, and/or Integrated HDD can be used for determining routine adjustments (e.g., as determined in act 506 in the example of FIG. 5).

FIG. 11 shows an illustrative GUI 1100 that allows configuration of routine adjustments and associated statistical analysis techniques that can vary across clients and verticals. In particular, GUI 1100 depicts configuration of routine adjustments relating to weather and trading hours. GUI 1100 allows the variables of interest to be defined, such as, CDD for weather and site opening hours for the trading hours. In addition to defining the variables of interest, the type of statistical analysis technique to be used for determining the routine adjustment is also defined by this illustrative GUI. For example, GUI 1100 depicts “Linear A+B*x (i.e., linear regression) being selected as the type of statistical analysis technique to be used for determining routine adjustments associated with weather and opening hours. As will be appreciated, other types of statistical methods can be used without departing from the scope of this disclosure.

In some embodiments, as shown in the example of FIG. 11, a granularity for the statistical analysis to be conducted may be defined. This granularity may identify the periodicity of data points associated with various times within the time period upon which the statistical analysis will be based, and may for instance use hourly data within the time period, daily data, weekly data, etc. The inventors have recognized that conventional systems that perform daily and monthly regression analysis may not be able to easily switch between different granularities. By providing the GUI 1100 that allows selection of different granularities, the inventors have recognized and appreciated that the statistical analysis can not only be switched from one granularity to another, but the results of the respective analysis can be readily propagated to subsequent acts (e.g., acts 508, 510, and 512, in the example of FIG. 5). For example, if a “daily” granularity is selected for the statistical analysis, but many missing data points are identified in the data, the granularity can be switched from “daily” to “monthly”, which automatically causes the statistical analysis to be performed on a monthly basis.

The inventors have recognized that non-routine adjustment determination (e.g., in act 508 in the example of FIG. 5), if performed on main meter data, may provide inaccurate results. Multiple different incidents and/or projects could be affecting a particular site at the same time and the main meter data includes data associated with all the different incidents and/or projects. The use of main meter data to determine an adjustment associated with a particular incident would deliver inaccurate results because the main meter data would be confounded by the other incidents effecting the site at the same time. The inventors have recognized and appreciated that the use of sub-meter data to perform the determination of non-routine adjustments significantly improves accuracy of the results. For example, when the determination is to be performed for a non-routine LED lighting upgrade project at a particular site, sub-meter data associated with the lighting load (i.e., load type or load category relating to lighting) for that site may be analyzed to determine how the resource consumption changed due to the project. Because the sub-meter data associated with the lighting load does not include data associated with any other incidents that may be effecting the site, the consumption for the non-routine adjustment can be accurately computed. Accordingly, in some embodiments, one or more techniques (performed by the baseline module, for example) described in connection with FIGS. 12-14 may be used to define sub-meter load types and determine non-routine adjustments for the defined load types.

FIG. 12 shows an illustrative GUI 1200 that allows configuration of various load types, load limits for the defined load types, default values for the defined load types, and adjustment types occurring during the baseline and reporting periods that are indicative of non-routine adjustments associated with particular load types. An upper portion 1202 of the GUI 1200 defines various load types and associated load limits. For example, in the upper portion 1202 of the GUI 1200, a first column titled “Name” lists various sub-meter load types, the second column titled “Data Source” defines parameterized queries that, at runtime, can acquire consumption and/or load data associated with the corresponding data sources (e.g., sub-meters), the third column titled “Low Limit” defines low limits for the various sub-meter load types, the fourth column titled “High Limit” defines high limits for the various sub-meter load types, and the fifth column titled “Default Value” defines default values for the various sub-meter load types. In some implementations, when the consumption and/or load data obtained from any particular data source indicates that the resource consumption and/or load value for a particular sub-meter load type is under the “Low Limit” or above the “High Limit”, an entry for that particular sub-meter load type is flagged in the upper portion 1202 of the GUI 1200 and the default value for the particular sub-meter load type is used for any subsequent consumption and savings determinations.

In some embodiments, a lower portion 1204 of the GUI 1200 defines various retrofit types (e.g., in the “left section” of portion 1204) that correspond to non-routine adjustments made during the baseline period and adjustment types (in the “right” section of portion 1204) that correspond to non-routine adjustments made during the reporting period. In addition, as shown in GUI 1200, each of the non-routine adjustment types can be associated a particular load type. For example, an “Essential Refrigeration” retrofit type is associated with a “Refrigeration” load type and an “Underground Car Park” adjustment type is associated with a “Lighting” load type, and so on. In some embodiments, the association of the non-routine adjustment types with load types allows accurate determination of an amount of consumption attributable to a particular incident (for example, retrofit types and/or adjustment types).

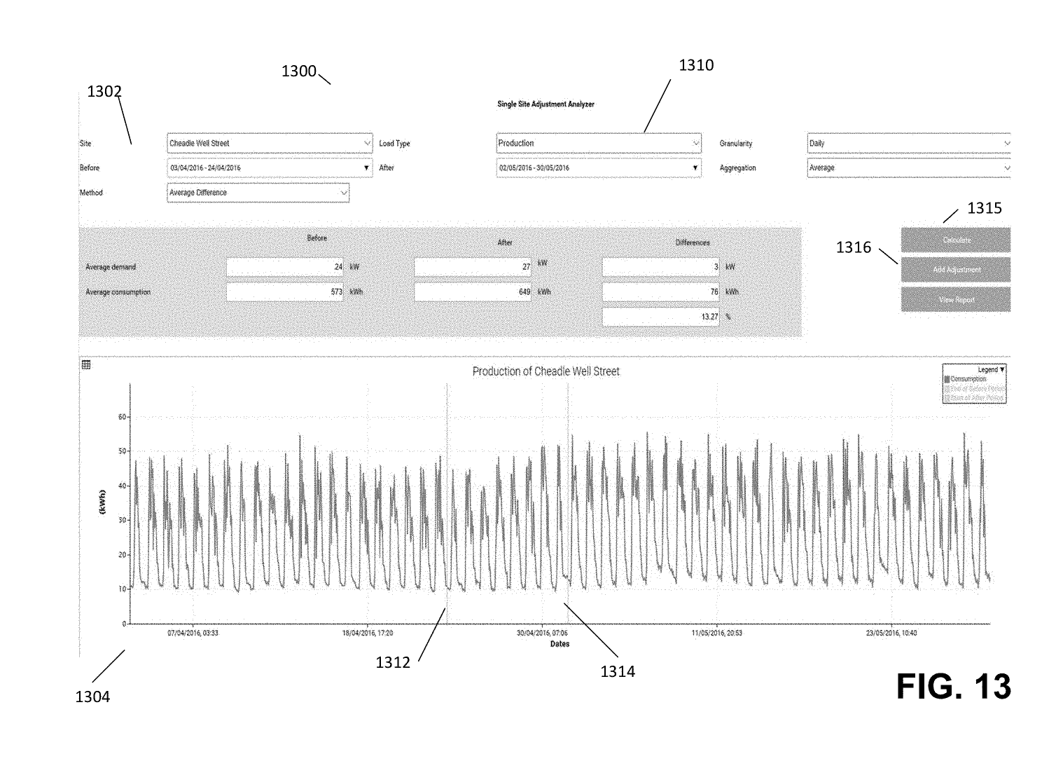

FIG. 13 shows an illustrative GUI 1300 that shows how non-routine adjustment analysis is carried out for a single site. In some embodiments, the non-routine adjustment analysis can be performed for different load types defined in GUI 1200 of FIG. 12. As shown in FIG. 13, a particular site and a particular load type may be selected for the analysis in an upper portion 1302 of the GUI 1300. For example, the load type may be selected via a drop-down menu 1310 that lists the different load types defined in GUI 1200 of FIG. 12. In some embodiments, a “before” period may be defined that refers to a time period before an incident has occurred at the site (e.g., a time period before a project is implemented at the site) and an “after” period may be defined that refers to a time period after an incident has occurred at the site (e.g., a time period after the project is implemented at the site). In some embodiments, an aggregation type and method to be used for the comparative analysis of the consumption data from the before and after periods is also defined (i.e., to determine any changes in sub-meter consumption data before and after the incident). In some implementations, a comparative analysis of the resource consumption data associated with a plurality of time points in the before period and the after period may be performed. For example, as shown in FIG. 13, an average difference method can be selected to determine an average difference between the consumption data associated with the before and after periods. Similarly, other methods can be selected without departing from the scope of the disclosure, such as, a normalized difference method.

In response to a selection of the “Calculate” button 1315 in GUI 1300, the non-routine adjustment analysis is performed based on a comparative analysis of the before and after periods and any amount of reduction or increase in consumption attributable to the incident is determined. In some embodiments, a first resource consumption value may be determined based on sub-meter consumption data associated with time points in the before period and a second resource consumption value may be determined based on sub-meter consumption data associated with time points in the after period. In some embodiments, the first resource consumption value may be determined by averaging sub-meter consumption data values associated with time points in the before period. Similarly, the second resource consumption value may be determined by averaging sub-meter consumption data values associated with time points in the after period. An amount of reduction or increase in resource consumption attributable to the incident may be determined based on a comparison between the first resource consumption value and the second resource consumption value. Referring back to the example shown in FIG. 13, the amount of reduction or increase is quantified as a difference in average demand and a difference in average consumption between the sub-meter consumption data before and after the project. In some embodiments, a lower portion 1304 of the GUI 1300 depicts an illustrative graph that depicts the resource consumption associated with the production load type during the before period, the after period, and any intervening period. For example, line 1312 depicts when the before period ends and line 1314 depicts when the after period starts. In this manner, a user is able to see, at a glance, what the resource consumption looked like during the before and after periods and how the resource consumption was impacted due to the occurrence of the incident during the intervening period.

In some embodiments in response to a selection of the “Add Adjustment” button 1316 in GUI 1300, the amount of reduction or increase in resource consumption (i.e., adjustment value) attributable to the incident may be applied to a portion of the baseline period corresponding to a time period after the occurrence of the event (e.g., the after period). In some embodiments, the adjustment value is applied to baseline resource consumption (e.g., baseline period effective consumption) corresponding to the time points subsequent to the occurrence of incident in the reporting period. For instance, reporting period baseline consumption may be created on a monthly-basis, by applying the adjustment value for a particular month to the baseline period effective consumption for that month. In some embodiments, the reporting period baseline consumption may be created on a weekly-basis.

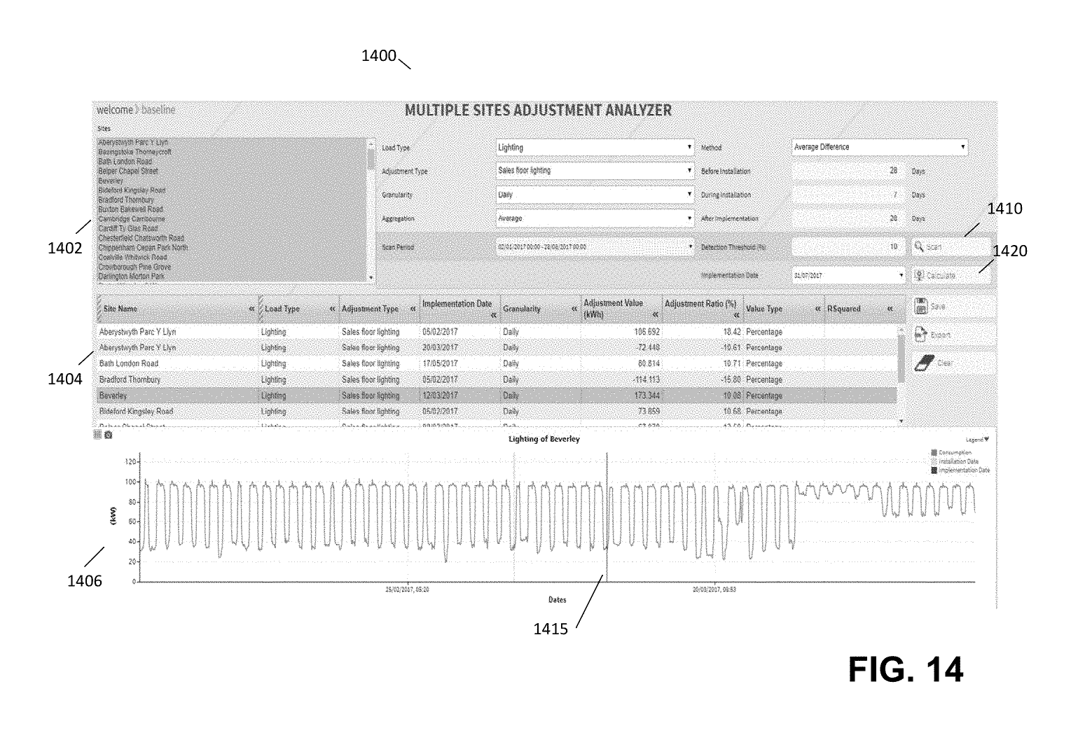

The inventors have recognized that an inability to identify incidents and include the non-routine adjustments corresponding to the incidents in the resource consumption calculations can lead to inaccurate savings measurements. For example, there may be instances where certain unknown non-routine changes were made that may be impacting a number of sites. Accordingly, in some embodiments, one or more techniques (performed by the baseline module, for example) described in connection with FIG. 14 are used to identify and address these unknown non-routine changes or incidents by analyzing load trends across multiple sites at the same time. FIG. 14 shows an illustrative GUI 1400 that allows the user to select, in an upper portion 1402 of the GUI 1400, one or more sites for the analysis (e.g., GUI 1400 depicts all sites being selected), the load type, the adjustment type, the type of aggregation, the method to be used for the comparative analysis of before and after periods (depicted in GUI 1400 as before installation and after implementation), and a scan period. In some embodiments, anomalies detected by the event detection module 130 may be analyzed to determine the scan period. For example, detection of certain anomalies during a particular time period may indicate that one or more incidents could have occurred during that time period. This time period can then be used as the scan period. In some embodiments, the scan period may be determined based on feedback regarding any change in expected consumption post implementation of one or more proposed consumption reduction measures. In some embodiments, the scan period may be determined based on data gathered from site and/or client visits, governance processes, and/or other data. In some embodiments, GUI 1400 allows the user to select a threshold value based on the load type. Including the threshold value ensures that routine changes are not taken into account during the analysis. In response to a selection of a “scan” button 1410 of the GUI 1400, the resource consumption of the lighting load in a selected scan period (Jan. 2, 2017-Aug. 28, 2017) for different selected sites is analyzed. Based on the analysis, an implementation date may be determined for each selected site, where the implementation date indicates when at least one incident (impacting the resource consumption of the site) may have occurred. In some embodiments, in response to a selection of a “calculate” 1420, a comparative analysis (similar to the analysis described in FIG. 13, for example) of the sub-meter consumption associated with the lighting load during a before period (indicated as 28 days before installation) and an after period (indicated as 28 days after implementation) can be performed based on the average difference method for each selected site. The results of the analysis are shown in a middle portion 1404 of the GUI 1400 that lists all the sites (of the selected sites) where the amount of reduction or increase in consumption attributable to the incident exceeds the threshold value. As shown in FIG. 14, a threshold value of 10% is selected for the lighting load type, however different threshold values may be selected for other load types. For each site in the list provided in the middle portion 1404, an adjustment value (i.e., amount of reduction or increase in consumption attributable to the incident) and an adjustment ratio is determined. In some implementations, the adjustment ratio is determined as adjustment value divided by total value of the respective load type. As shown in FIG. 14, the adjustment ratio of all the sites in the middle potion 1404 exceeds the threshold value of 10%. In some implementations, for sites where the adjustment ratios that exceed the threshold value, the adjustment value attributable to the incident may be applied to a portion of the baseline period corresponding to a time period after the occurrence of the incident. In some embodiments, the adjustment value is applied to baseline resource consumption (e.g., baseline period effective consumption) corresponding to the time points subsequent to the occurrence of incident in the reporting period. For instance, reporting period baseline consumption may be created on a monthly-basis, by applying the adjustment value for a particular month to the baseline period effective consumption for that month. In some embodiments, the reporting period baseline consumption may be created on a weekly-basis.

In some embodiments, selection of a particular site in the listing provided in middle portion 1404 of GUI 1400, causes an exemplary graph depicting resource consumption for the selected site to be displayed in lower portion 1406 of the GUI 1400. FIG. 14 depicts the resource consumption associated with the lighting load type for a particular site (e.g., “Beverley”) where the implementation date associated with an incident is depicted by line 1415. While the foregoing analysis is described as being performed on sub-meter consumption data, it will be appreciated that the analysis can also be performed on main meter consumption data.

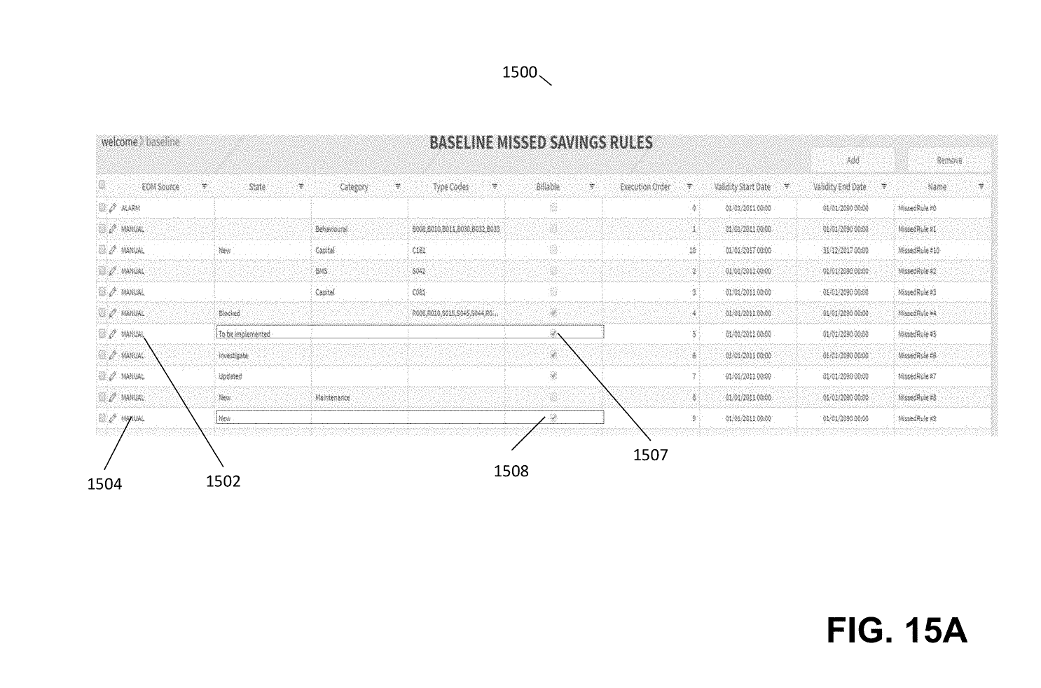

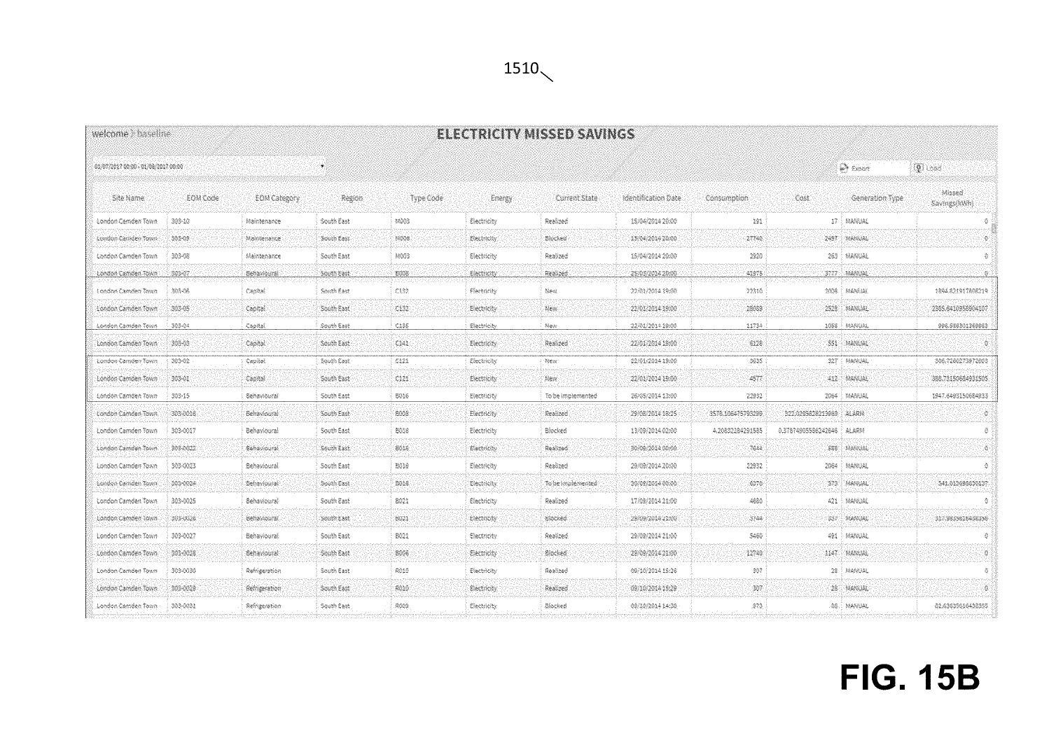

FIGS. 15A and 15B show illustrative GUIs 1500, 1510 that visually depict missed savings, in accordance with some embodiments. The inventors have recognized and appreciated that it may be beneficial to allow a user to visually identify any savings that are being missed because one or more consumption reduction measures have not been implemented. Accordingly, in some embodiments, techniques (performed by the baseline module, for example) are provided in connection with FIGS. 15A and 15B that allow a user to understand what savings could have been achieved had the consumption reduction measures been implemented.

FIG. 15A shows an illustrative GUI 1500 that allows “missed savings” rules to be defined. As shown in FIG. 15A, “missed savings” rules can be defined for one or more states of an event (as described in relation to FIG. 4, for example). For example, a rule 1502 may be defined for an event in a “to be implemented” state. Similarly, a rule 1504 may be defined for an event in a “new state”. In some embodiments, one or more of the defined rules can be selected for determination of missed savings. For example, as shown in FIG. 15A, selection of check boxes 1507 and 1508 causes the rules 1502 and 1504 to be selected for inclusion in missed savings calculations.

In some implementations, the rules defined in FIG. 15A, when executed, cause the missed savings to be calculated and presented. In some embodiments, the missed savings represent the total kWh and cost value that is missed because of the events being in the “to be implemented” and “new” states. FIG. 15B shows an illustrative GUI 1510 that depicts the calculated missed savings (in kWh) for events with states “to be implemented” and “new”. It will be appreciated that while missed saving rules have been described for “new” and “to be implemented” states, any suitable missed saving rule may be defined for different states.

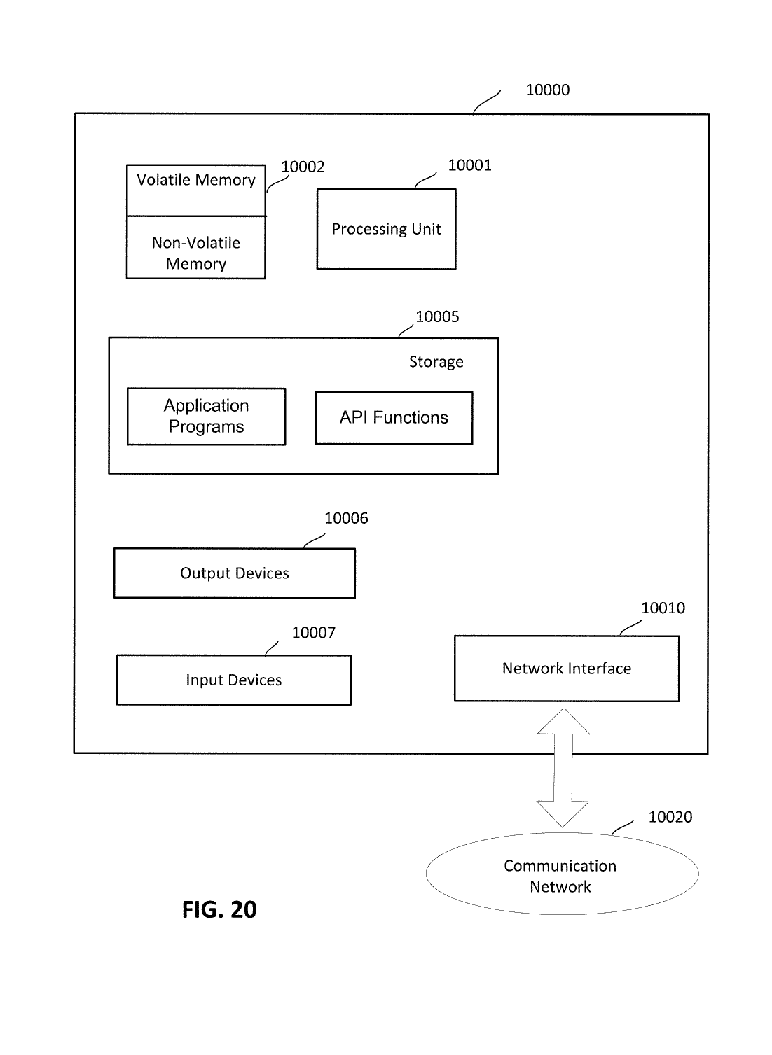

FIG. 20 shows, schematically, an illustrative computer 10000 on which any aspect of the present disclosure may be implemented. In the embodiment shown in FIG. 20, the computer 10000 includes a processing unit 10001 having one or more processors and a non-transitory computer-readable storage medium 10002 that may include, for example, volatile and/or non-volatile memory. The memory 10002 may store one or more instructions to program the processing unit 10001 to perform any of the functions described herein. The computer 10000 may also include other types of non-transitory computer-readable medium, such as storage 10005 (e.g., one or more disk drives) in addition to the system memory 10002. The storage 10005 may also store one or more application programs and/or external components used by application programs (e.g., software libraries), which may be loaded into the memory 10002.

The computer 10000 may have one or more input devices and/or output devices, such as devices 10006 and 10007 illustrated in FIG. 20. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards and pointing devices, such as mice, touch pads, and digitizing tablets. As another example, the input devices 10007 may include a microphone for capturing audio signals, and the output devices 10006 may include a display screen for visually rendering, and/or a speaker for audibly rendering, recognized text.

As shown in FIG. 20, the computer 10000 may also comprise one or more network interfaces (e.g., the network interface 10010) to enable communication via various networks (e.g., the network 10020). Examples of networks include a local area network or a wide area network, such as an enterprise network or the Internet. Such networks may be based on any suitable technology and may operate according to any suitable protocol and may include wireless networks, wired networks or fiber optic networks.

Having thus described several aspects of at least one embodiment, it is to be appreciated that various alterations, modifications, and improvements will readily occur to those skilled in the art. Such alterations, modifications, and improvements are intended to be within the spirit and scope of the present disclosure. Accordingly, the foregoing description and drawings are by way of example only.

The above-described embodiments of the present disclosure can be implemented in any of numerous ways. For example, the embodiments may be implemented using hardware, software or a combination thereof. When implemented in software, the software code can be executed on any suitable processor or collection of processors, whether provided in a single computer or distributed among multiple computers.

Also, the various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

In this respect, the concepts disclosed herein may be embodied as a non-transitory computer-readable medium (or multiple computer-readable media) (e.g., a computer memory, one or more floppy discs, compact discs, optical discs, magnetic tapes, flash memories, circuit configurations in Field Programmable Gate Arrays or other semiconductor devices, or other non-transitory, tangible computer storage medium) encoded with one or more programs that, when executed on one or more computers or other processors, perform methods that implement the various embodiments of the present disclosure discussed above. The computer-readable medium or media can be transportable, such that the program or programs stored thereon can be loaded onto one or more different computers or other processors to implement various aspects of the present disclosure as discussed above.

The terms “program” or “software” are used herein to refer to any type of computer code or set of computer-executable instructions that can be employed to program a computer or other processor to implement various aspects of the present disclosure as discussed above. Additionally, it should be appreciated that according to one aspect of this embodiment, one or more computer programs that when executed perform methods of the present disclosure need not reside on a single computer or processor, but may be distributed in a modular fashion amongst a number of different computers or processors to implement various aspects of the present disclosure.

Computer-executable instructions may be in many forms, such as program modules, executed by one or more computers or other devices. Generally, program modules include routines, programs, objects, components, data structures, etc. that perform particular tasks or implement particular abstract data types. Typically the functionality of the program modules may be combined or distributed as desired in various embodiments.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that conveys relationship between the fields. However, any suitable mechanism may be used to establish a relationship between information in fields of a data structure, including through the use of pointers, tags or other mechanisms that establish relationship between data elements.

Various features and aspects of the present disclosure may be used alone, in any combination of two or more, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

Also, the concepts disclosed herein may be embodied as a method, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Use of ordinal terms such as “first,” “second,” “third,” etc. in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Also, the phraseology and terminology used herein is for the purpose of description and should not be regarded as limiting. The use of “including,” “comprising,” “having,” “containing,” “involving,” and variations thereof herein, is meant to encompass the items listed thereafter and equivalents thereof as well as additional items.

In some embodiments, one or more of the following aspects may be provided, in any suitable combination.
1. A system comprising: at least one computer-readable storage medium storing executable instructions; and at least one processor programmed by the executable instructions to present a visual representation of resource savings that are attributable to one or more consumption reduction measures, the visual representation comprising: at least one first column representing baseline resource consumption for a reporting period; at least one second column representing actual resource consumption during the reporting period; and a horizontal band intersecting the at least one first column, wherein a height of the horizontal band corresponds to a difference between a height of the at least one first column representing baseline resource consumption for the reporting period and a height of the at least one second column representing actual resource consumption during the reporting period.
2. The system of aspect 1, wherein a top edge of the horizontal band is aligned vertically with a top edge of the at least one first column representing baseline resource consumption for the reporting period; and a bottom edge of the horizontal band is aligned vertically with a top edge of the at least one second column representing actual resource consumption during the reporting period.
3. The system of aspect 1, wherein the visual representation further includes at least one third column relating to at least one independent variable having an impact on resource consumption during the reporting period.
4. The system of aspect 3, wherein the at least one processor is further programmed to: estimate a relationship between resource consumption and the at least one independent variable; and determine a height of the at least one third column based at least in part on the estimated relationship, and first and second values of the at least one independent variable, wherein the first value corresponds to a baseline period, and the second value corresponds to the reporting period.
5. The system of aspect 1, wherein the visual representation further includes: at least one fourth column relating to at least one incident taking place in the reporting period and having an impact on resource consumption subsequent to the at least one incident.
6. The system of aspect 5, wherein the at least one processor is further programmed to: determine a height of the at least one fourth column based at least in part on resource consumption data prior to the at least one incident and resource consumption data subsequent to the at least one incident.
7. The system of aspect 1, wherein the visual representation further includes: at least one fifth column representing actual resource consumption during a baseline period; and at least one sixth column representing effective resource consumption during the baseline period.
8. The system of aspect 7, wherein: the at least one fifth column is disposed adjacent to the at least one sixth column; the visual representation further includes: at least one third column relating to at least one independent variable having an impact on resource consumption during a reporting period; and at least one fourth column relating to at least one incident taking place in the reporting period and having an impact on resource consumption subsequent to the at least one incident; the at least one third column and the at least one fourth column are disposed between the at least one sixth column and the at least one first column; and the at least one third column is disposed adjacent to the at least one fourth column.
9. A method performed by the system of any of aspects 1-8.
10. At least one computer-readable storage medium storing computer-executable instructions that, when executed, cause at least one processor to perform the method of aspect 9.
11. A method for adjusting a baseline resource consumption, the adjustment being associated with at least one incident impacting resource consumption during a reporting period, the method comprising: acquiring resource consumption data from one or more resource consumption sub-meters for a plurality of time points during the reporting period; establishing a first resource consumption value based on resource consumption data associated with time points during the reporting period prior to occurrence of at least one incident; establishing a second resource consumption value based on resource consumption data associated with time points during the reporting period subsequent to occurrence of the at least one incident; determining an amount of reduction or increase in resource consumption attributable to the at least one incident based on a comparison between the first resource consumption value and the second resource consumption value; and applying an adjustment based on the determined amount of reduction or increase to a baseline resource consumption corresponding to one or more time points subsequent to the occurrence of the at least one incident in the reporting period to produce a reporting period baseline consumption.
12. The method of aspect 11, wherein determining an amount of reduction or increase in resource consumption further comprises: determining a difference between the first resource consumption value and the second resource consumption value.
13. The method of aspect 11, further comprising: generating a visual representation comprising: a visual representation of resource consumption associated with the time points prior to the occurrence of the at least one incident; a visual representation of resource consumption associated with the time points subsequent to the occurrence of the at least one incident; and a visual representation of an impact of the at least one incident on the resource consumption associated with the time points subsequent to the occurrence of the at least one incident.
14. The method of aspect 11, wherein establishing the first resource consumption value comprises averaging a first plurality of resource consumption data values associated with the time points during the reporting period prior to occurrence of at least one incident.
15. The method of aspect 14, wherein establishing the second resource consumption value comprises averaging a second plurality of resource consumption data values associated with the time points during the reporting period subsequent to occurrence of at least one incident.
16. The method of aspect 11, wherein the resource consumption data is acquired from one or more electrical sub-meters.
17. The method of aspect 11, wherein the one or more resource consumption meters are associated with a particular load type.
18. The method of aspect 11, wherein the reporting period baseline consumption includes a second adjustment corresponding to at least one variable that continuously and regularly impacts the resource consumption data during the reporting period.
19. The method of aspect 11, wherein acquiring resource consumption data from one or more resource consumption sub-meters further comprises: acquiring the resource consumption data from one or more resource consumption sub-meters associated with a plurality of sites; and identifying, for each site of the plurality sites, when the at least one incident has occurred.
20. The method of aspect 19, further comprising: for each site of the plurality of sites: establishing the first resource consumption value based on resource consumption data associated with time points during the reporting period prior to occurrence of the at least one incident; establishing the second resource consumption value based on resource consumption data associated with time points during the reporting period subsequent to occurrence of the at least one incident; and determining an amount of reduction or increase in resource consumption attributable to the at least one incident based on a comparison between the first resource consumption value and the second resource consumption value.
21. The method of aspect 20, further comprising: determining whether the determined amount of reduction or increase in resource consumption attributable to the at least one incident exceeds a threshold value.
22. The method of aspect 21, wherein applying an adjustment based on the determined reduction or increase to a baseline resource consumption further comprises: applying the adjustment based on the determined amount of reduction or increase to the baseline resource consumption in response to a determination that the determined amount of reduction or increase exceeds the threshold value.
23. A system comprising at least one computer-readable storage medium storing computer-executable instructions that, when executed, cause at least processor to perform the method of any of aspects 11-22.
24. At least one computer-readable storage medium storing computer-executable instructions that, when executed, cause at least one processor to perform the method of any of aspects 11-22.

What is claimed is:

1. A system comprising:
at least one computer-readable storage medium storing executable instructions; and
at least one processor programmed by the executable instructions to present a visual representation of resource savings that are attributable to one or more consumption reduction measures, the visual representation comprising:
at least one first column representing baseline resource consumption for a reporting period;
at least one second column representing actual resource consumption during the reporting period; and
a horizontal band intersecting the at least one first column, wherein a height of the horizontal band corresponds to a difference between a height of the at least one first column representing baseline resource consumption for the reporting period and a height of the at least one second column representing actual resource consumption during the reporting period.

2. The system of claim 1, wherein:
a top edge of the horizontal band is aligned vertically with a top edge of the at least one first column representing baseline resource consumption for the reporting period; and
a bottom edge of the horizontal band is aligned vertically with a top edge of the at least one second column representing actual resource consumption during the reporting period.

3. The system of claim 1, wherein the visual representation further includes:
at least one third column relating to at least one independent variable having an impact on resource consumption during the reporting period.

4. The system of claim 3, wherein the at least one processor is further programmed to:
estimate a relationship between resource consumption and the at least one independent variable; and
determine a height of the at least one third column based at least in part on the estimated relationship, and first and second values of the at least one independent variable, wherein the first value corresponds to a baseline period, and the second value corresponds to the reporting period.

5. The system of claim 1, wherein the visual representation further includes:
at least one fourth column relating to at least one incident taking place in the reporting period and having an impact on resource consumption subsequent to the at least one incident.

6. The system of claim 5, wherein the at least one processor is further programmed to:
determine a height of the at least one fourth column based at least in part on resource consumption data prior to the at least one incident and resource consumption data subsequent to the at least one incident.

7. The system of claim 1, wherein the visual representation further includes:
at least one fifth column representing actual resource consumption during a baseline period; and
at least one sixth column representing effective resource consumption during the baseline period.

8. The system of claim 7, wherein:
the at least one fifth column is disposed adjacent to the at least one sixth column;
the visual representation further includes:
at least one third column relating to at least one independent variable having an impact on resource consumption during a reporting period; and
at least one fourth column relating to at least one incident taking place in the reporting period and having an impact on resource consumption subsequent to the at least one incident;
the at least one third column and the at least one fourth column are disposed between the at least one sixth column and the at least one first column; and
the at least one third column is disposed adjacent to the at least one fourth column.

9. A computer-implemented method comprising:
presenting a visual representation of resource savings that are attributable to one or more consumption reduction measures, the visual representation comprising:
at least one first column representing baseline resource consumption for a reporting period;
at least one second column representing actual resource consumption during the reporting period; and
a horizontal band intersecting the at least one first column, wherein a height of the horizontal band corresponds to a difference between a height of the at least one first column representing baseline resource consumption for the reporting period and a height of the at least one second column representing actual resource consumption during the reporting period.

10. The method of claim 9, wherein:
a top edge of the horizontal band is aligned vertically with a top edge of the at least one first column representing baseline resource consumption for the reporting period; and
a bottom edge of the horizontal band is aligned vertically with a top edge of the at least one second column representing actual resource consumption during the reporting period.

11. The method of claim 9, wherein the visual representation further includes:
at least one third column relating to at least one independent variable having an impact on resource consumption during the reporting period.

12. The method of claim 11, further comprising:
estimating a relationship between resource consumption and the at least one independent variable; and
determining a height of the at least one third column based at least in part on the estimated relationship, and first and second values of the at least one independent variable, wherein the first value corresponds to a baseline period, and the second value corresponds to the reporting period.

13. The method of claim 9, wherein the visual representation further includes:
at least one fourth column relating to at least one incident taking place in the reporting period and having an impact on resource consumption subsequent to the at least one incident.

14. The method of claim 13, further comprising:
determining a height of the at least one fourth column based at least in part on resource consumption data prior to the at least one incident and resource consumption data subsequent to the at least one incident.

15. The method of claim 9, wherein the visual representation further includes:
at least one fifth column representing actual resource consumption during a baseline period; and
at least one sixth column representing effective resource consumption during the baseline period.

16. The method of claim 15, wherein:
the at least one fifth column is disposed adjacent to the at least one sixth column;
the visual representation further includes:
at least one third column relating to at least one independent variable having an impact on resource consumption during a reporting period; and
at least one fourth column relating to at least one incident taking place in the reporting period and having an impact on resource consumption subsequent to the at least one incident;
the at least one third column and the at least one fourth column are disposed between the at least one sixth column and the at least one first column; and
the at least one third column is disposed adjacent to the at least one fourth column.

17. At least one computer-readable storage medium storing computer-executable instructions that, when executed, cause at least one processor to perform a method comprising:
presenting a visual representation of resource savings that are attributable to one or more consumption reduction measures, the visual representation comprising:
at least one first column representing baseline resource consumption for a reporting period;
at least one second column representing actual resource consumption during the reporting period; and
a horizontal band intersecting the at least one first column, wherein a height of the horizontal band corresponds to a difference between a height of the at least one first column representing baseline resource consumption for the reporting period and a height of the at least one second column representing actual resource consumption during the reporting period.

18. The at least one computer-readable storage medium of claim 17, wherein:
a top edge of the horizontal band is aligned vertically with a top edge of the at least one first column representing baseline resource consumption for the reporting period; and
a bottom edge of the horizontal band is aligned vertically with a top edge of the at least one second column representing actual resource consumption during the reporting period.

19. The at least one computer-readable storage medium of claim 17, wherein the visual representation further includes:
at least one third column relating to at least one independent variable having an impact on resource consumption during the reporting period.

20. The at least one computer-readable storage medium of claim 19, wherein the computer-executable instructions further cause the at least one processor to:
estimate a relationship between resource consumption and the at least one independent variable; and
determine a height of the at least one third column based at least in part on the estimated relationship, and first and second values of the at least one independent variable, wherein the first value corresponds to a baseline period, and the second value corresponds to the reporting period.

21. The at least one computer-readable storage medium of claim 17, wherein the visual representation further includes:
at least one fourth column relating to at least one incident taking place in the reporting period and having an impact on resource consumption subsequent to the at least one incident.

22. The at least one computer-readable storage medium of claim 21, wherein the computer-executable instructions further cause the at least one processor to:
determine a height of the at least one fourth column based at least in part on resource consumption data prior to the at least one incident and resource consumption data subsequent to the at least one incident.

23. The at least one computer-readable storage medium of claim 17, wherein the visual representation further includes:
at least one fifth column representing actual resource consumption during a baseline period; and
at least one sixth column representing effective resource consumption during the baseline period.

24. The at least one computer-readable storage medium of claim 23, wherein:
the at least one fifth column is disposed adjacent to the at least one sixth column;
the visual representation further includes:
at least one third column relating to at least one independent variable having an impact on resource consumption during a reporting period; and
at least one fourth column relating to at least one incident taking place in the reporting period and having an impact on resource consumption subsequent to the at least one incident;
the at least one third column and the at least one fourth column are disposed between the at least one sixth column and the at least one first column; and
the at least one third column is disposed adjacent to the at least one fourth column.
